(19) United States
(12) Patent Application Publication
(10) Pub. No.: US 2006/0071489 A1
(43) Pub. Date: Apr. 6, 2006

(54) Control device with multiple switching

(76) Inventors: Herve' Bricaud, Dole (FR); Yves Pizard, Dole (FR); David Ferraton, Crissey (FR)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/213,578

(22) Filed: Aug. 26, 2005

(30) Foreign Application Priority Data
Sep. 1, 2004 (FR) FR 0409247

(51) Int. Cl. B66C 1/00

(52) U.S. Cl. 294/67.3

(57) ABSTRACT

A control device includes a control member (32) that is rotatable about an axis on a casing (22), with a gearwheel (100) mounted on the control member shaft to repeatedly flick a deflectable contact element (10) that is formed from a piece of sheet metal and that has vertical stems connected by elbows. The control member is manually depressable and has shaft ends (44, 46) that slide vertically in slots (48, 50) of the casing so either end of the control member can be depressed. An elastomeric member (34) lies in the casing and has upwardly projecting tubes (310, 314) that surround contacts, with the tops of the tubes being downwardly deflectable.

### CROSS-REFERENCE

Applicant claims priority from French application 0409247 filed Sep. 1, 2004.

### BACKGROUND OF THE INVENTION

The need for a control device that is compact and of very small dimensions for moving a cursor on a screen, and/or to scroll menus (scanning), also called a “browser”, is increasingly important on apparatus of the “mobile telephone” or “personal digital assistant” type. It is also desirable to be able to have at least one select function on which the user presses to make a choice corresponding to the position reached by the cursor on the screen by manipulating a control member. Furthermore, the predicted increase in screen dimension, of the order of 40 by 80 mm, requires a powerful browser to control movement and selection rapidly and with precision. These needs are further increased when the control device or browser is used in the context of a game.

The tactile sensation transmitted by the device to the user of the browser is an important parameter for its performance and user-friendliness. The sensitivity of the user's sense of touch is such that it allows him to perceive discrete or continuous, extremely fine variations, so it is possible to transmit a complex “message” to a user's finger or hand.

In the case of a movement or scanning, such information or tactile sensations are for example mechanical pulses or “clicks” corresponding to each electric signal or pulse produced by the browser sent to the electronic signal or data processing circuits of the apparatus, or corresponding to series of pulses. Other mechanical pulses or “clicks”, usually of a different intensity and nature from the foregoing, indicate electricity supplied to the electronic circuits during a manual confirmation or selection action, for example when a target has been reached. The market requires a major enhancement in the reliability of this type of control device or browser, particularly with respect to the sealing of the electric contact zones from dust, which results in taking account of this requirement when the product is designed.

### SUMMARY OF THE INVENTION

In accordance with one embodiment of the invention, a miniature control device is provided that is of simple and rugged design, that enables multiple selections to be manually made. The control device includes a moveable control member that is rotatable about an axis, that carries a gearwheel, and that repeatedly flicks a deflectable contact member. The contact member is formed of a piece of sheet metal that includes a plurality of vertical stems connected by elbows. A manually moveable control member has vertically slideable opposite ends, and can generate signals by depressing either end or its middle. A sheet metal tripping member has opposite branches that lie under opposite ends of the control member, so only one of the branches in depressed against a contact when one end of the control member is depressed. An elastomeric sealing member lies under the control member and has upstanding tubes that contain contacts, each tube being downwardly deflectable by a branch of the tripping member.

Other characteristics and advantages of the invention will become apparent on reading the derailed description which follows for the understanding of which reference may be made to the appended drawings, in which:

### BRIEF DESCRIPTION OF THE DRAWINGS

FIG. 1 is top isometric view of a first embodiment of a control device with five switching channels according to the invention;

FIG. 2 is an exploded isometric view of the device of FIG. 1;

FIG. 3 is an isometric view of the underside of the device of FIG. 1;

FIG. 4 is a top view in larger scale of the device of FIG. 1;

FIG. 5 is a side view of the device of FIG. 1;

FIG. 6 is a top and front right isometric view of the device of FIG. 1 without its top cover for enclosing the bottom casing;

FIG. 7 is a view similar to that of FIG. 6, from the opposite angle;

FIGS. 8, 9, 10 and 12 are views similar to that of FIG. 6 which illustrate various stages of installation of the components (in a configuration without contact springs R1) in the lower part of the casing;

FIG. 11 is a view similar to that of FIG. 9 which illustrates a configuration with two springs R1 and without springs R2 or R3;

FIG. 13 is a top view of FIG. 8;

FIG. 14 is a top view in large scale of FIG. 12;

FIG. 15 is a view in section along the vertical and longitudinal midplane 15-15 of FIG. 14;

FIGS. 16 to 22 are views along the cross-sectional planes 16-16 to 22-22 of FIG. 15 corresponding more particularly to second and third configurations each requiring a pair of first contact springs R1;

FIGS. 23 and 24 are views similar to those of FIG. 15 which illustrate the device when a force F3 or F2 is applied to the drum;

FIG. 25 is a view similar to that of FIG. 15 which illustrates the device when a central force F1 is applied to the drum;

FIG. 26 is a view similar to that of FIG. 18 which illustrates the device when a central force F1 is applied to the drum;

FIG. 27 is a an enlarged isometric view of the deflectable contact element of FIG. 2 made out of stamped metal sheet according to the teachings of the invention;

FIG. 28 is a side view of the deflectable contact element taken along arrow F28 of FIG. 27;

FIG. 29 is an end view of FIG. 28;

FIG. 30 is a top isometric view of the top cover enclosing the device;

FIG. 31 is a top isometric view of the cover of FIG. 30;

FIGS. 32 and 33 are isometric views of the drum of the device of FIG. 2;

FIG. 34 is an isometric view of the common trigger member of FIG. 2;

FIG. 35 is a top view of the common trigger member;

FIG. 36 is an end view of the common trigger member;

FIGS. 37 and 38 are isometric views from above and below of the sealing and support block of FIG. 2;

FIG. 39 is an isometric view of the damper and sealing block of FIG. 2;

FIG. 40 is an isometric view of the member forming a pawl for drag and tactile sensation that interacts with the wheel associated with the drum of FIG. 33;

FIGS. 41 and 42 are isometric views from above and below that illustrate the device according to the invention of FIGS. 1 and 3 mounted by an elastic socket joint into a portion of a wall of an electronic apparatus equipped with such a device;

FIGS. 43 and 44 are views similar to those of FIGS. 41 and 42 that illustrate the portion of wall of the electronic apparatus without the device;

FIGS. 45 to 47 are views similar to those of FIGS. 34 to 36 that illustrate a variant embodiment of the common trigger member making it possible to dispense with the central fixed contact ball;

FIG. 48 is a view similar to that of FIG. 15 that illustrates a variant embodiment adapted to receive the common trigger member illustrated in FIGS. 45 to 47;

FIG. 49 is a view similar to that of FIG. 15 that illustrates a preferred embodiment of the sealing and guide piece and of the frustoconical contact springs;

FIG. 50 is a detail view in larger scale of a part of FIG. 49;

FIG. 51 is a view similar to that of FIG. 15 that illustrates an embodiment complying with the fifth configuration without springs and without contact ball;

FIGS. 52 to 57 are various isometric and sectional views (along the corresponding planes indicated on the figures) that illustrate a first exemplary embodiment of a control device with drum with only two switching channels, “UP” and “DOWN”;

FIGS. 58 to 64 are another series of isometric, sectional and elevation views that illustrate another exemplary embodiment of a control device with two switching channels of the type represented in FIGS. 52 to 57;

FIGS. 65 to 72 are various views that illustrate an exemplary embodiment of the teachings of the invention in a control device with “Trackball” type ball.

### DESCRIPTION OF THE PREFERRED EMBODIMENT

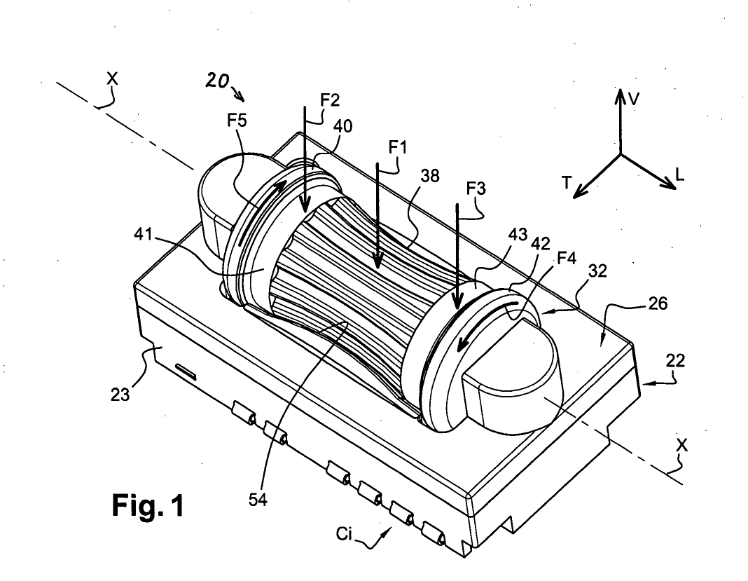

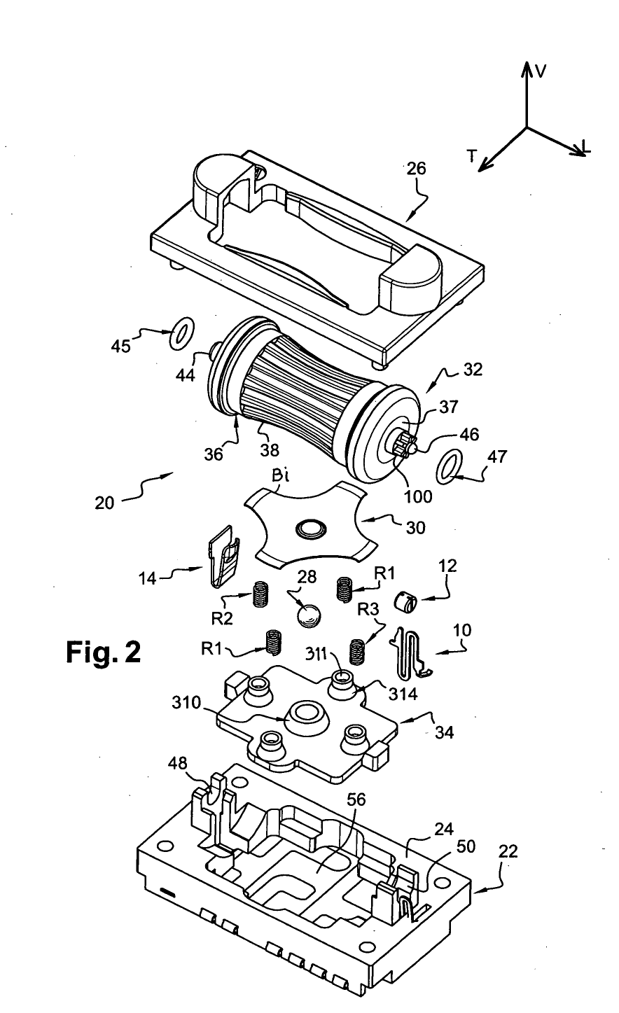

Limited Description of the Invention FIG. 1 illustrates a control device or system 20 which includes a movable control member 32 that generates signals when it is depressed at locations F1, F2, or F3, and when it its rotated in either direction F4 or F5 about an axis of rotation X-X. The control member lies in a casing that has a lower part 22. FIG. 2 shows that the control member 30 has a pair of shaft portions or shafts 44, 46 that can lie in slots 48, 50 in upstanding parts of the lower casing.

The lower casing 22 may be molded of a rigid engineering plastic or other material. An elastomeric sealing member, or elastomeric member 34 lies in a cavity of the lower casing 22 and a contact ball 28 lies in a center tube 310 of the sealing member. Bottom contacts in the form of coil springs R1, R1, R2 and R3 lie in passages 311 in other, peripheral tubes 314 of the elastomeric member. A sheet metal trigger member 30 has a center that lies on top of the center tube 310 and the ball therein, and has four branches Bi that lie on top of the peripheral tubes 314 of the sealing member. (“Bi” refers to branches in general, while B1, B2, B3 refer to particular branches). When a selected end of the control member 32 is depressed, the control member depresses one of the branches Bi of the trigger member until that branch engages one of the bottom contacts that lies in one of the sealing member tubes 314. When the middle of the control member is depressed, two opposite branches engage corresponding bottom contacts in other ones of the tubes.

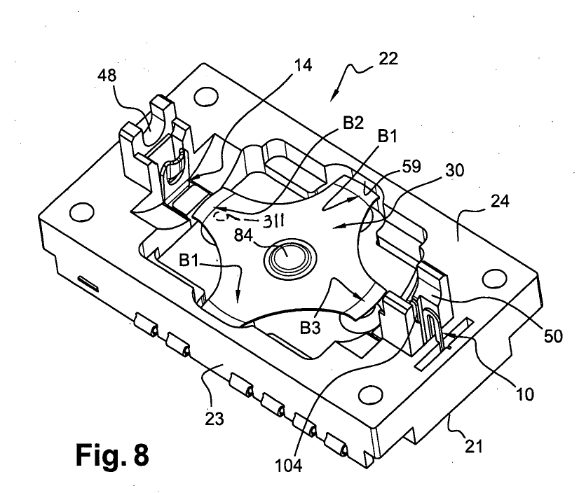

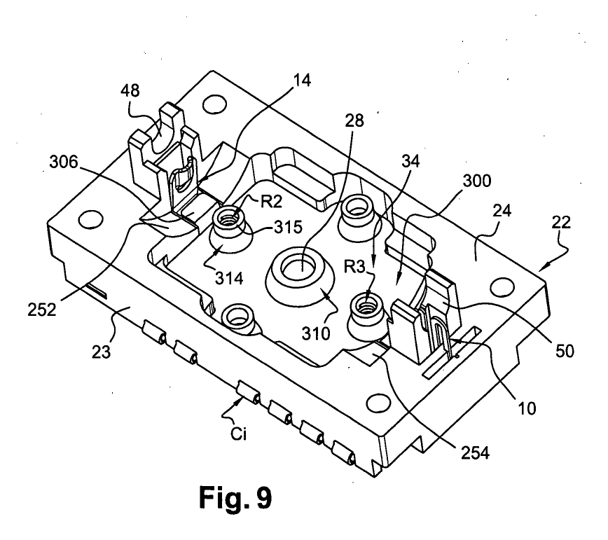

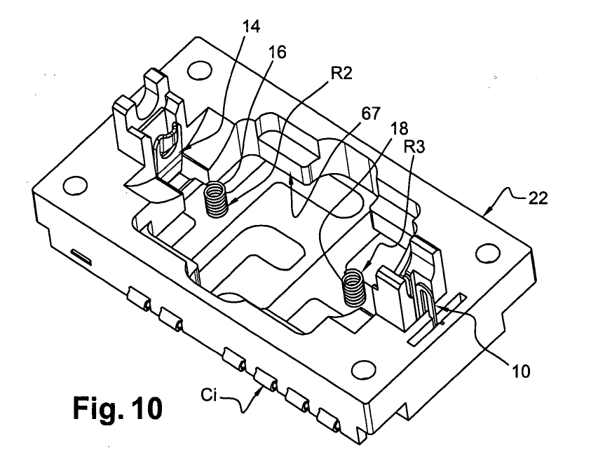

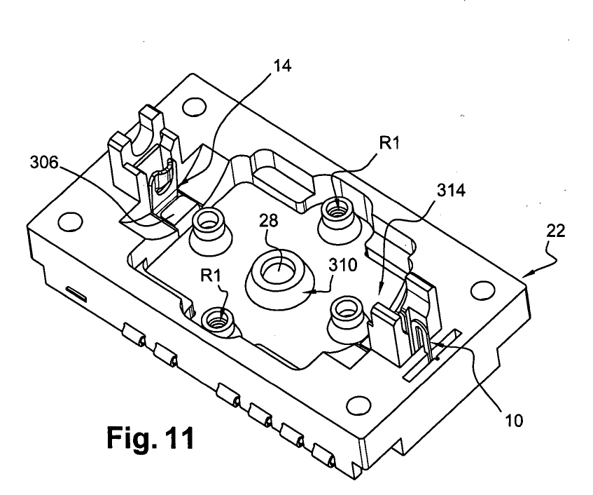

FIG. 8 shows that each branch such as B2 and B3 completely covers the passage 311 in the elastomeric tube that the branch lies over. This helps keep dirt and dust away from the contacting surfaces.

A gearwheel 100 is mounted on one shaft portion 46 of the control member. A deflectable contact element 10 that is formed of sheet metal, has one part fixed to the lower casing and another part lying in the path of the teeth of the gearwheel 100. Deflections of the deflectable contact element 10 cause a part of it to engage contacts, to detect the direction and amount of rotation of the control member.

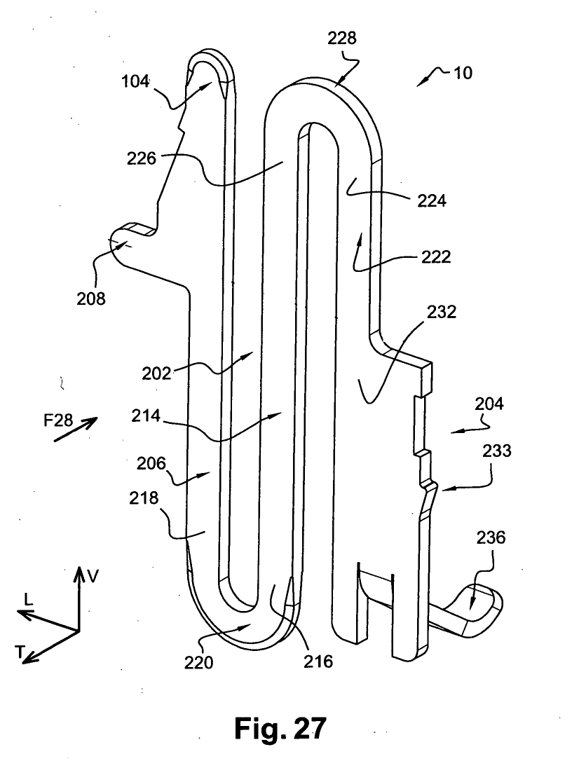

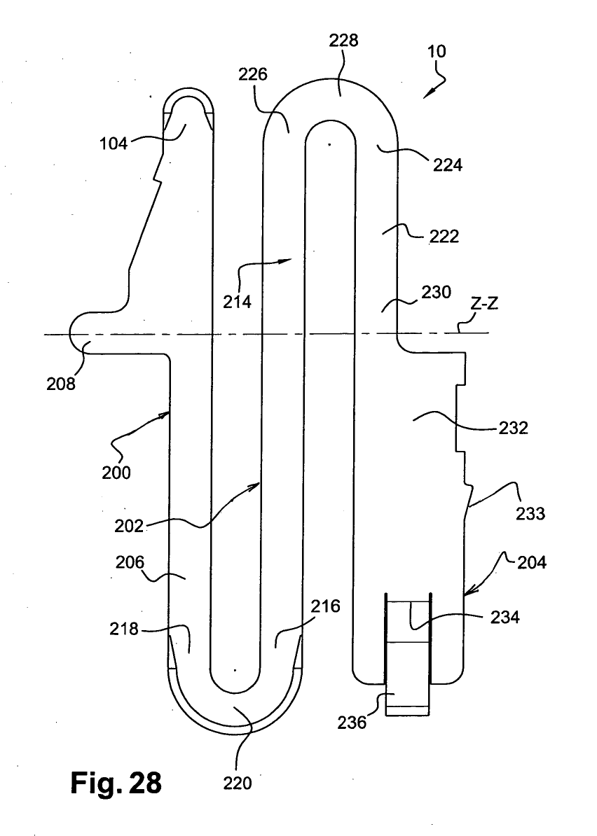

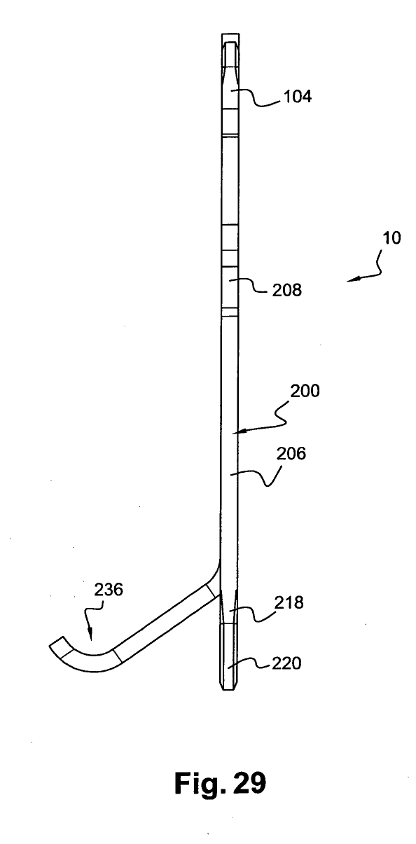

FIG. 27-29 show details of the sheet metal deflectable contact element 10 that detects rotation of the control member. FIG. 28 shows that the contact element has three vertically elongated stems, including a first or free end stem 204, a second or intermediate stem 202, and a third or main stem 200. A lower elbow 220 connects the bottoms of the second and third stems, and an upper elbow 228 connects the tops of the first and second stems. Each elbow is formed by a portion of the sheet metal that has been cut to extend in about a 1800 loop about a corresponding axis that extends normal to the plane of the sheet metal. All stem and elbow parts of the deflectable contact element preferably lie in a single plane.

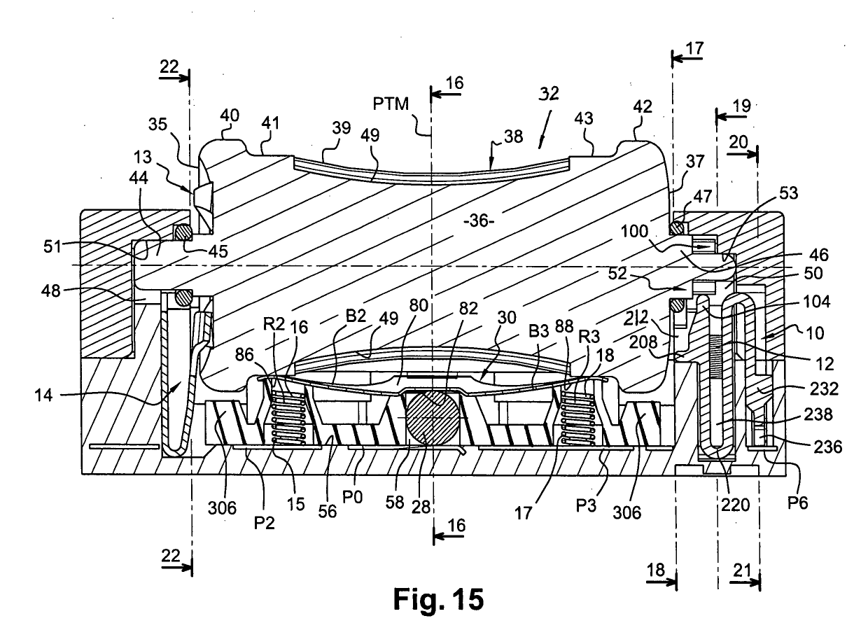

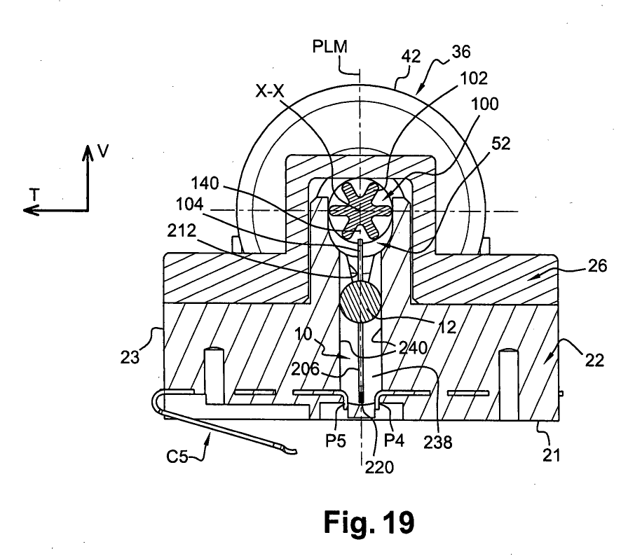

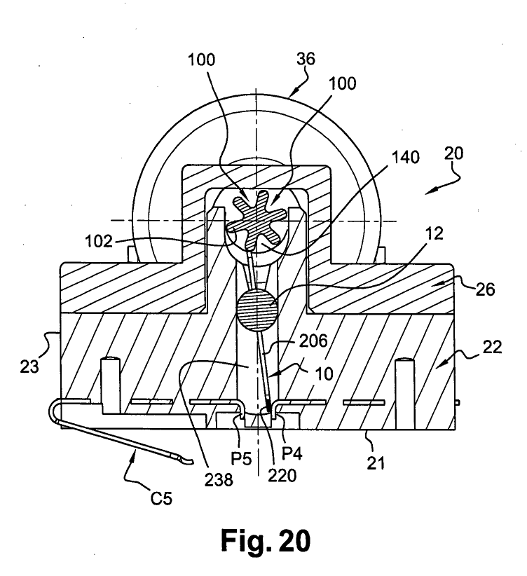

FIG. 15 shows that the deflectable contact element 10 is located with a mount part 232 of the first stem mounted in the casing and with a foot 236 pressing against a contact pad P6. A deflectable portion 104 at the top of the third stem lies between teeth of the gearwheel to be deflected every time a tooth passes by the deflectable portion. A contact portion formed at or adjacent to the lower elbow 220 engages contacts when the deflectable portion 104 is deflected. FIG. 19 shows that the lower elbow 220 deflects against contact P4 or P5 every time a tooth 102 of the gearwheel 100 deflects the deflectable portion 104. FIG. 20 shows the control member turning in a clockwise direction as seen in the figure, and shows a section 206 of the third stem deflecting so the lower elbow 220 repeatedly engages the contact P4.

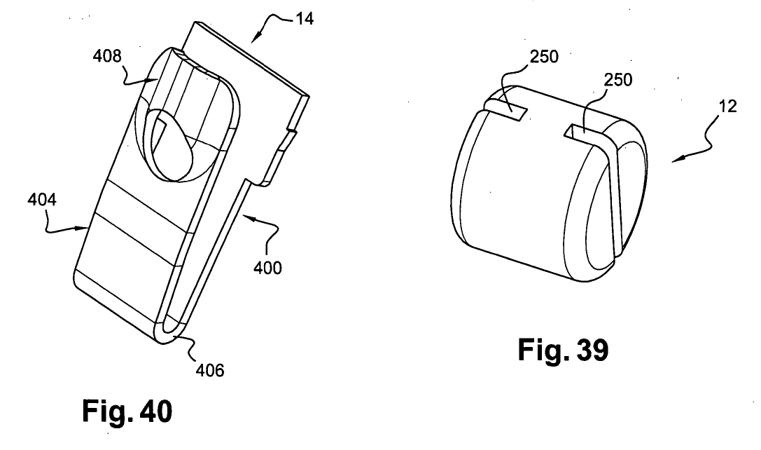

An elastomeric damper element 12 is mounted on the middle of the second and third stems. FIG. 39 shows that the damper element 12 has a pair of slot portions or slots 250 that each receives one of the stems to dampen vibrations. FIG. 15 shows that the third stem has an articulation branch 208 that projects into a slot 212 in the casing and that lies against a bottom wall of the slot. The articulation branch prevents the deflectable portion 104 from moving under the gearwheel, and locates the deflectable portion 104 directly under the axis of the gearwheel so the plane of the third stem passes through the gearwheel axis.

FIG. 15 shows that the trigger member 30 has a central portion 82 that forms an upstep and that lies against the ball 28. The ball constantly engages a contact pad P0, so the trigger member is constantly connected to the contact pad P0. The trigger member has opposite branches B2 and B3 that each presses upward against a different end of the control member 32. O-rings 45, 47 that extend around parts of the shafts 44, 46 that do not lie on the slots 48, 50, limit upward movement of opposite ends of the control member.

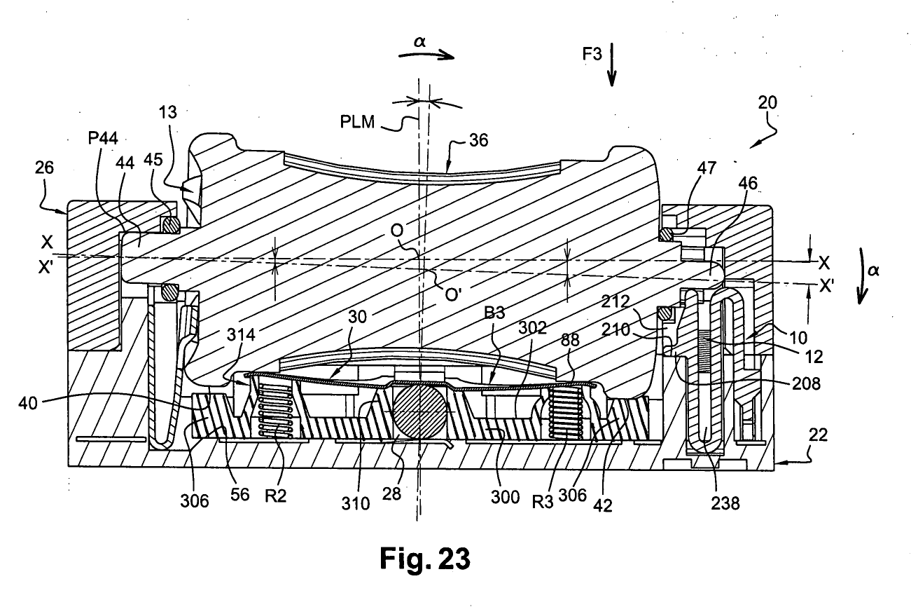

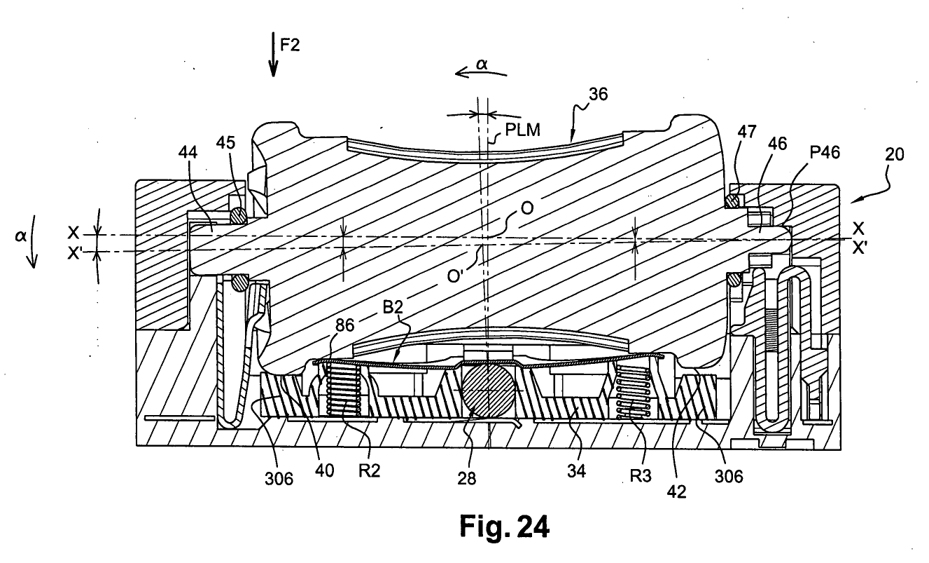

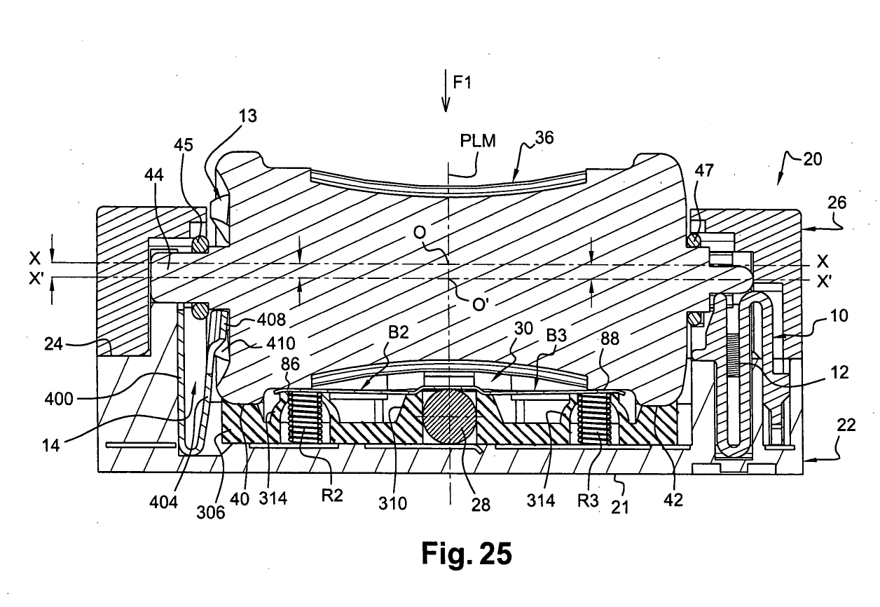

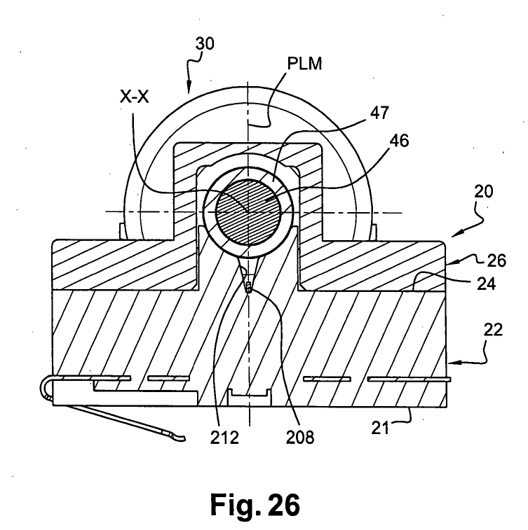

When one end of the control member is depressed, a corresponding one of the shafts slides downward in its slot. FIG. 23 shows that when a downward force F3 is applied to the control member, over the right end 88 of trigger member branch B3, the branch end 88 is depressed. The trigger branch end 88 then compresses the corresponding elastomeric tube and engages the top of the corresponding contact formed by coil spring R3. FIG. 24 shows a force F2 applied to the left end of the control member, which depresses the end 86 of trigger member branch B2 into engagement with the spring R2. FIG. 25 shows that when a force F1 is applied to the middle of the control member, both trigger member branches are depressed and both of the opposite branches B2 and B3 engage their corresponding contact springs R2 and R3. The fact that contact is established simultaneously with both branches indicates that the force was applied to the middle of the control member.

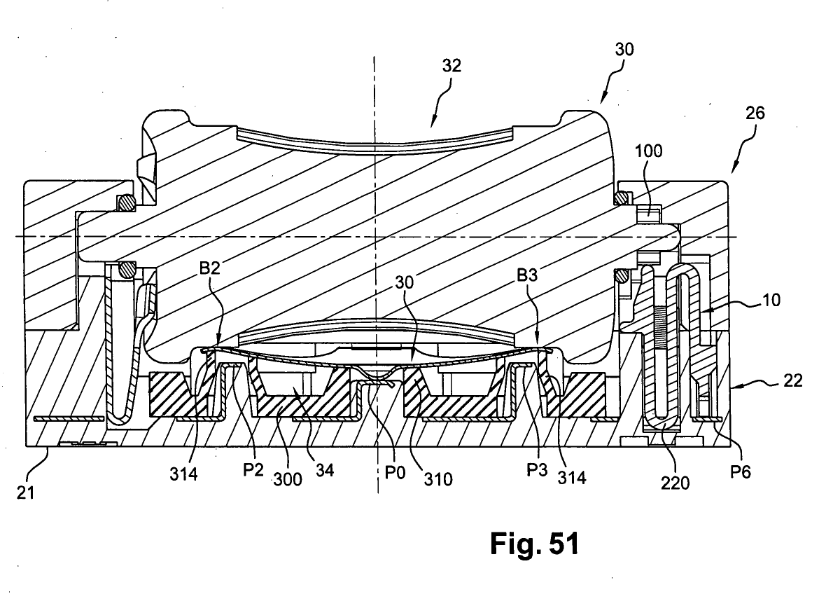

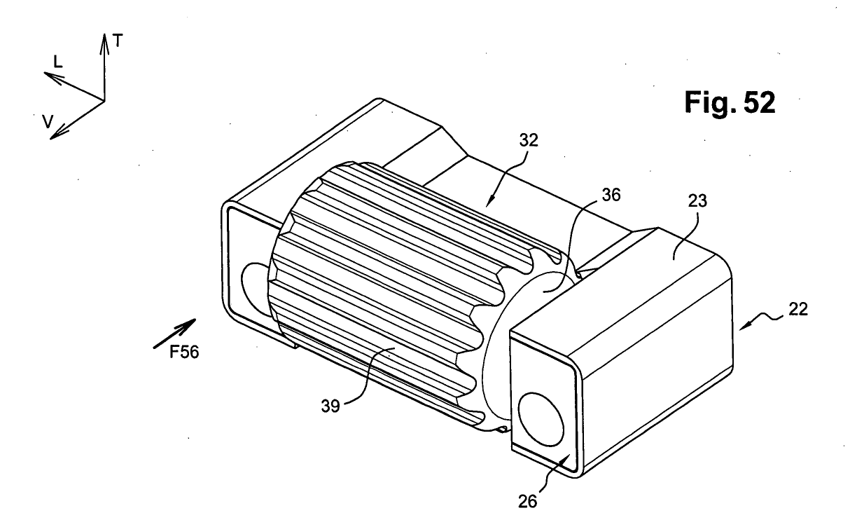

FIG. 15 shows that the springs R2 and R3 are each connected to a contact pad P2, P3. Current passes from the contact pad P0, through the trigger member 30, and though the springs and corresponding contact pads to close circuits. The upstep 82 at the middle of the trigger member 30 is always spaced from the control member 32. The ends 86, 88 of the trigger member branches press upward against smooth tracks 41, 43 of the control member. FIG. 51 shows that fixed bottom contacts such as those formed by the contact pads P0, P1 and P2 can be used to engage the trigger member.

FIG. 15 shows that the a center region 38 of the control member has ribs to help turn the control member. The ends 86, 88 of the trigger member branches press upward against smooth tracks 41, 43 at opposite ends of the drum of the control member. FIG. 25 shows that end sections 40, 42 of the control member bottom on heels 306 of the elastomeric sealing member when the control member is depressed.

The additional springs R1 (FIG. 2) lie in transversely separated tubes 314 of the sealing member, with branches B1 (FIG. 8) of the trigger member lying over the springs R1. When both branches B1 engage the springs R1, this confirms that the middle of the control member has been depressed.

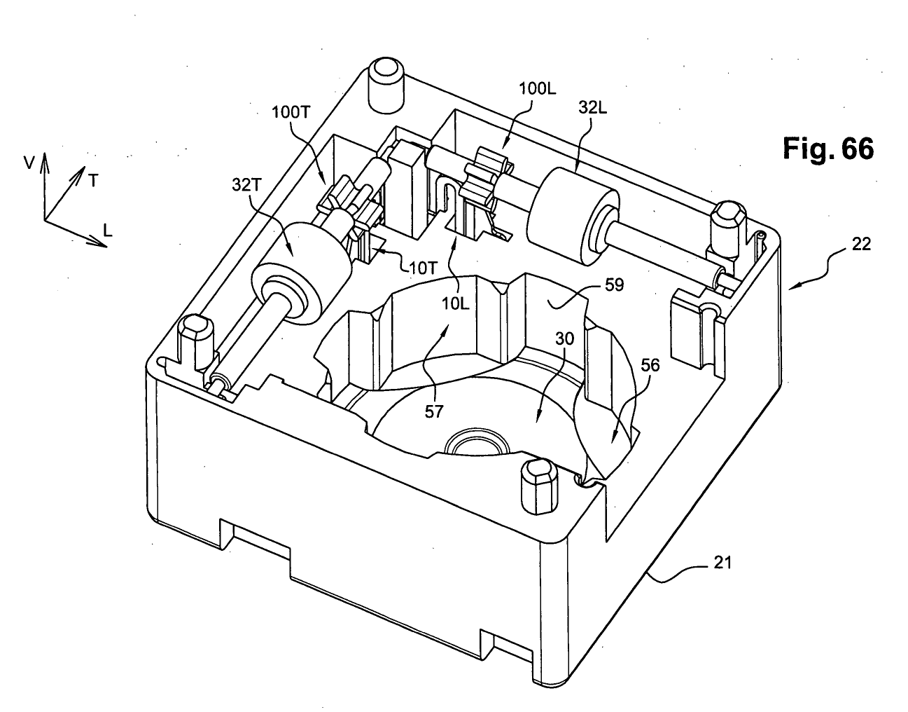

While the control member 32 of FIG. 15 is directly manually moveable, the features of the invention are applicable to control member that are indirectly moveable. FIG. 65 shows the top of a control device that uses a trackball 600 that is manually turned about two horizontal axes and that can be depressed. FIG. 66 shows that turning of the ball causes indirect turning of one or two control members 32T and 32L, which sometimes may be referred to as rollers. The rollers lie on shafts that also hold gearwheels 100T, 100L that each engages a corresponding deflectable contact element 10T, 10L.

While terms such as “top”, “boftom”, etc. have been used to describe the control device as illustrated, the control device can be used in any orientation.

### DETAILED DESCRIPTION OF THE INVENTION

For the description of the invention, the vertical, longitudinal and transverse orientations will be adopted as a non-limiting measure according to the V, L, T mark indicated in FIG. 1.

As a convention, the terms lower, upper, front, rear and left, right will be adopted with reference to FIG. 1.

In the description that follows, identical, similar or analogous elements belonging to the embodiments according to the invention will be indicated by the same numeric or alphanumeric references.

The control device 20 (FIG. 2) comprises a lower casing 22 with a general substantially rectangular parallelepipedic shape whose upper face 24 is open upwards, and a top cover 26 for enclosing the lower casing that houses the main components of the device 20.

These components comprise, from bottom to top and in the bottom of the casing 22, two contact springs, left R2 and right R3, where necessary two front and rear contact springs R1 depending on the configurations adopted that will be explained in detail hereinafter, and a central fixed contact ball 28, and a mobile contact element 10 belonging to a rotary signal generator in association with two fixed contact pads P4 and P5 (FIG. 19).

Then, from bottom to top, a guide and sealing piece 34 common to the contact springs Ri, a central trigger member 30 in the general shape of a trigger star with four branches Bi, a single manual control member 32 in the form of a drum 36 with longitudinal and horizontal rotation axis X-X, with its two end O-rings, left 45 and right 47.

The casing 22 further houses, on the right, an anti-rebound and sealing damper element 12 associated with the mobile contact element 10, and, on the left, an elastic element 14 forming a pawl for producing mechanical pulses or “clicks” in cooperation with an associated toothed wheel 18 (FIG. 15) of the ratchet type supported by the drum 36.

The single manual control member 32 essentially consists of a rotary operating drum 36 whose central section 38 is of reduced diameter and with a dished concave profile, relative to its two longitudinal end sections, left 40 (FIG. 1) and right 42, which here have a convex profile each in the form of a radial rib projecting radially outwards relative to the adjacent track 41, 43.

This shape is not mandatory. For certain applications, use may be made of a generally cylindrical drum with rectilinear external generatrix and making use of distinct surface states for the various sections, for example by means of materials offering different sensations to the touch.

As a variant, the outer profile of the central part of the drum may also be convex, non-rectilinear.

The sections 40 and 42 (FIG. 1) here are smooth, that is to say with no longitudinal ribs.

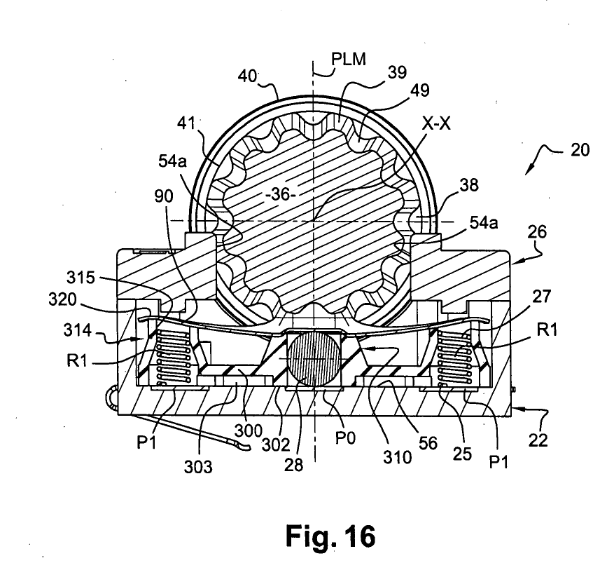

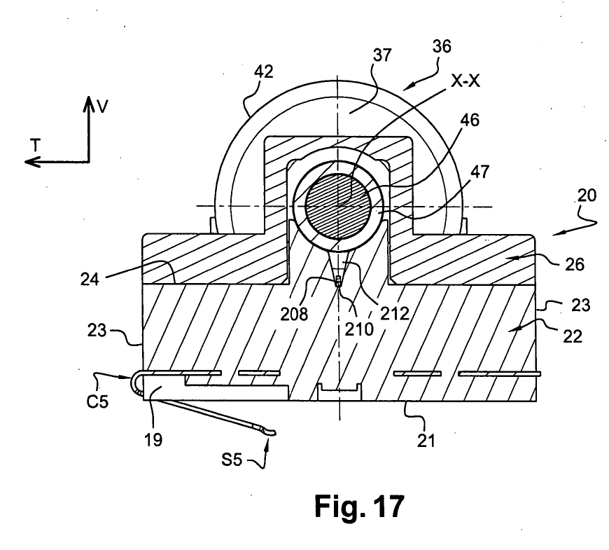

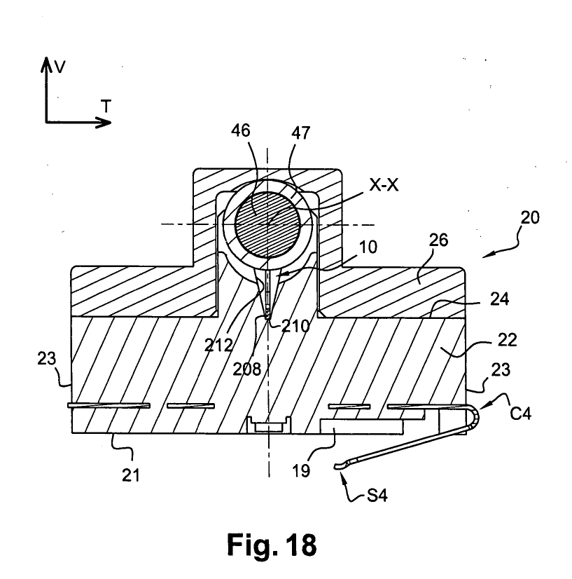

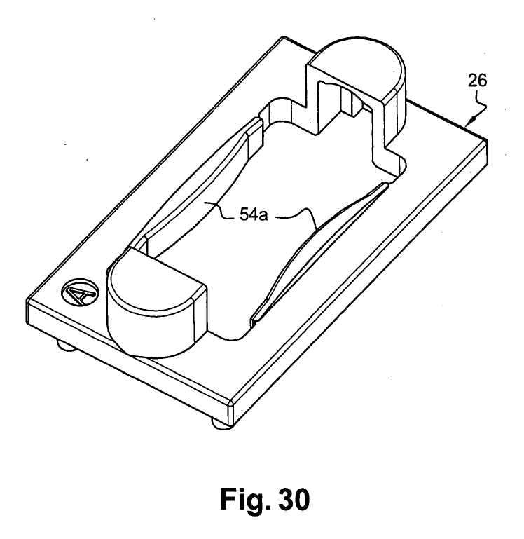

The drum 36 is designed to be rotated by its thinner central part 38 which comprises for this purpose longitudinal ribs 39 (FIG. 15) which are distributed angularly in a regular manner and separated by as many grooves 49 (in particular see FIGS. 16, 32 and 33).

Here again, it is possible to dispense with the ribs 39 in particular when the central part comprises a coating offering a very good grip to the touch.

Dispensing with the ribs makes it possible to more easily resolve the problems of sealing in relation to the outside at the clearance existing between the drum and the opening 54 (FIG. 1) provided in the cover 26 for the drum to pass. Specifically, the dished form of the central section 38 and the presence of the ribs 39 tends to cause contaminants and dust to be dragged inside the casing when the drum is rotated since, as can be seen in particular in FIGS. 16, 30 and 31, the peaks of the drum ribs move very closely across the adjacent ribs 54a with a profile that complements the opening 54 of the cover 26.

The control member 32 (FIG. 2) has two end or shaft sections, 44, 46, constituting a shaft for the rotatable mounting of the control member 32 in the lower casing 22. The lower casing has two semi-cylindrical upward-opening recesses 48, 50, receiving in rotation and vertically sliding the corresponding shaft section 44, 46 respectively. Each recess 48, 50 is covered by a wall of the lower face of the cover 26.

As shown in FIG. 15, an O-ring 45 lies at the inner end of the left shaft section 44 between a recess in the cover and in the lower casing. Another O-ring 47 lies on the right shaft section 46. The right shaft section 46 is stopped, and receives with clearance, a toothed gearwheel 100.

The O-rings 45 and 47 have the function of providing an anti-impact noise damping effect during the manipulations of the control member 32 and particularly when it is actuated in the directions by depressing it at F1, F2 and F3 (FIG. 1).

The control device or browser 20 (FIG. 2) here is a device with five switching channels each of which may be used independently of the others by applying a corresponding force to the control member 32.

As shown in FIG. 25, the first switching channel is a “SELECT” channel which is used by applying a vertical force F1 on the central section of the drum 36. This is used for example to select or confirm a determined position reached by a cursor on a screen of an electronic apparatus (not shown) fitted with the control member, or browser 32, each application of a vertical force F1 being used to produce a selection signal or pulse.

The second switching channel is for example a channel for “LEFT” movement towards the left of the screen, which is activated by applying a vertical force F2 (FIG. 24) on the left section 40 of the drum 36, each application of a vertical force F2 being used to produce a “LEFT” movement signal or pulse.

In symmetrical manner, the third switching channel is for example a channel for “RIGHT” movement towards the right of the screen which is used by applying a vertical force F3 (FIG. 23) on the right section 42 of the drum 36, each application of a vertical force F3 being used to produce a “RIGHT” movement signal or pulse. The circuits of the controlled electronic apparatus may provide that, if the user holds the drum down in the F2 or F3 direction, the pulses are repeated in continuous streams of identical pulses (scrolling), in the same manner as for a computer keyboard when the key is held down.

The fourth switching channel is, for example a channel for “DOWN” movement towards the bottom of the screen which is used by applying to the central part 38 of the drum 36 a circular force F4 (FIG. 1) tending to make it rotate in a first direction to generate a series of control signals or pulses by means of a signal generator which is shown in FIG. 20.

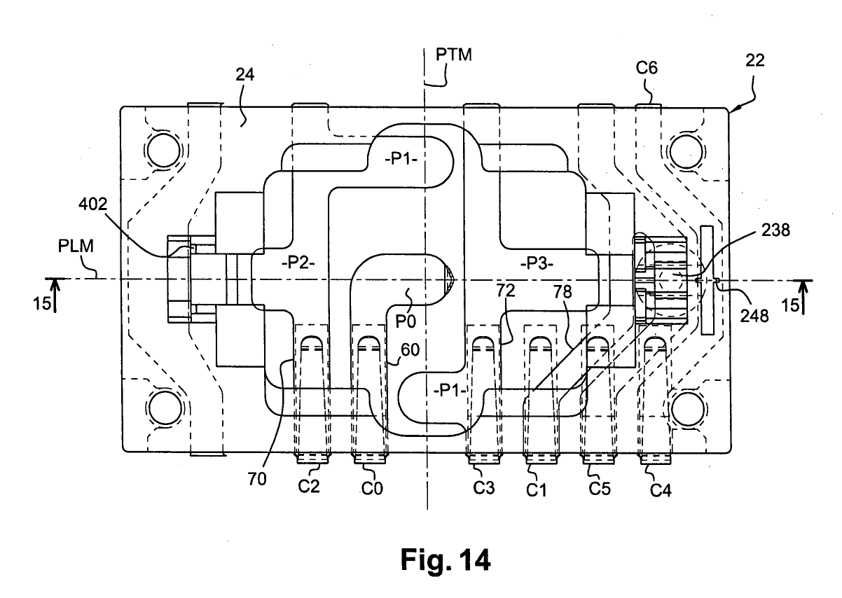

In symmetrical manner, the fifth switching channel is for example a channel for “UP” movement towards the top of the screen which is used by applying to the drum 36 (FIG. 1) a circular force F5 tending to make it rotate in a second direction to generate a series of control signals or pulses by means of the signal generator. The signal generating device 20 has a symmetry of design relative to the vertical and longitudinal mid-plane PLM (FIG. 14) in which the axis X-X (FIG. 1) of rotation of the control member 32 is situated, and a general symmetry relative to the vertical and transverse mid-plane PTM. However, there is an exception by the means forming the signal generator 52 which lies in the right part of the casing 22, and the means 14, 13 (FIG. 15) generating tactile and auditive pulses, situated on the left, and with the exception of the corresponding output contacts.

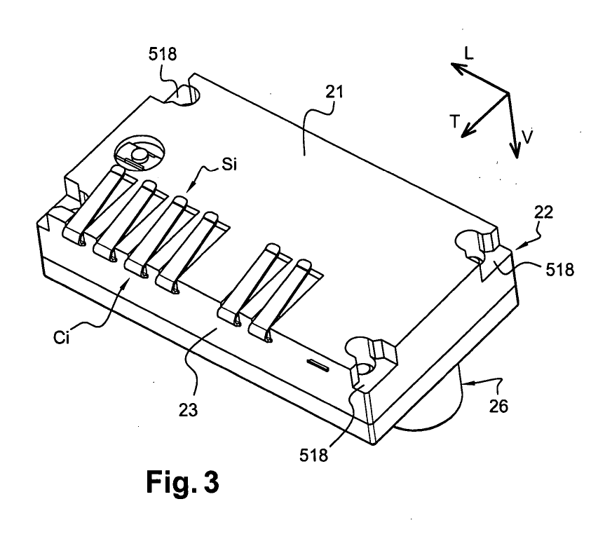

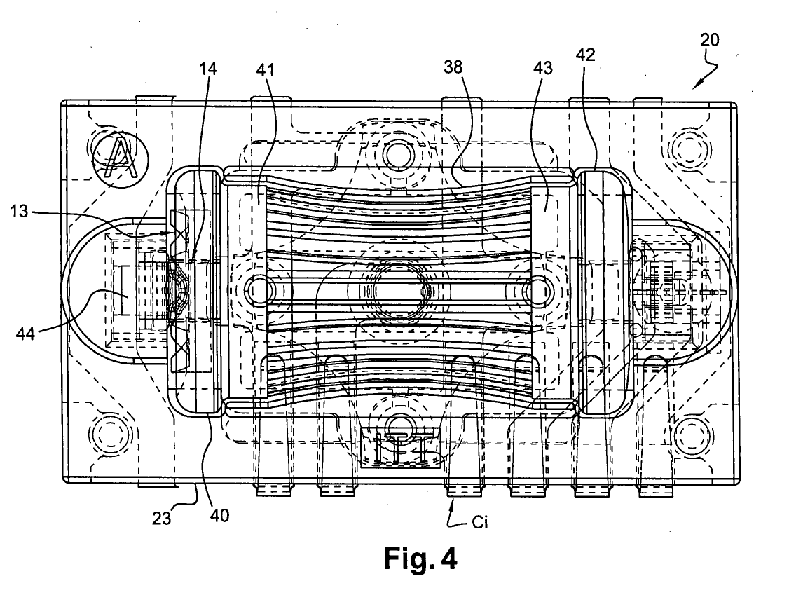

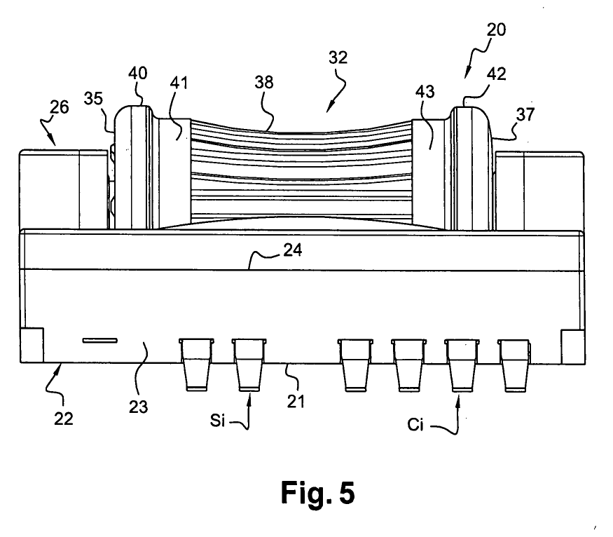

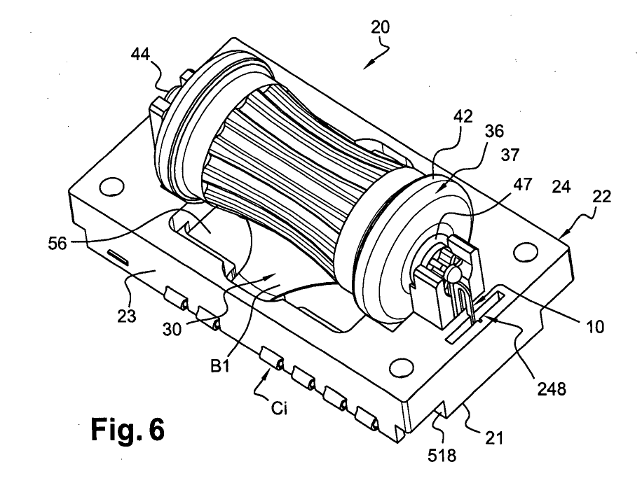

The center of the flat horizontal bottom 56 (FIG. 15) of the casing receives the central metal ball 28 which protrudes vertically above the plane 56. The ball 28 interacts with a central common fixed contact pad P0 which is connected, via a conductive track 60 (FIG. 14), to an output pin or lug C0 which protrudes transversely forwards in the lower part of the front longitudinal face of the casing 22. As can be seen more precisely in FIGS. 1 and 3, the output pin or lug C0, like all the lugs Ci, extends while being bent substantially at 1800 in a hairpin shape in order to form a lower free end stem S0 (Si) which extends substantially horizontally rearwards beneath the lower face 21 of the casing 22. To the right of each stem Si, the lower face 21 comprises a complementary recess inside which each stem Si may penetrate in order to allow the elastic flexing of the stem when the latter is pressed onto a corresponding conductive track of a printed circuit board (not shown) on which the device 20 is mounted.

As can be seen in the figures, the output lugs or pins “Ci” may be “duplicated” in the two front and rear faces 23. This is obtained directly from the contact grid around which the lower part of the casing is overmoulded.

It is also possible, depending on the applications, to distribute the outputs in one or other of these two front and rear faces 23. This is particularly advantageous for the resoldering of the soldered outputs in order to “balance” the soldering of the latter on the face of the printed circuit board in order to obtain a better mechanical attachment of the device on the board which is achieved only by soldering of the outputs. In a known manner, the soldered output lugs are of the “J” type oriented away from the casing, or of the “G” type bent back beneath the lower casing 22.

The contact grid shown particularly in FIG. 1 corresponds to the configurations that do not use a pair of springs R1 (FIG. 2).

Each fixed contact spring R2, R3 (FIG. 15) is a helical flanged spring of vertical axis and it rests, via its bottom end coil 15, 17, on a second P2 and a third P3 fixed conductive pad each of which is connected, via a conductive track 70, 72 (FIG. 14) to an output pin or lug C2, C3.

In the configurations in which they are present, each of the two fixed contact springs, front and rear R1 (FIG. 16), is a helical flanged spring of vertical axis and rests, via its bottom end coil 25, on a first fixed conductive pad P1. The pads P1 here are connected via a common conductive track 78 (FIG. 14) to a common output pin or lug C1.

The common star-shaped trigger member 30 (FIG. 15) (which will now be described in detail) may, depending on the different configurations, be used to establish selectively a (first) switching channel between the pads P0 and P1 (through the fixed contact springs R1, FIG. 16), a (second) switching channel between the pads P0 and P2 (through the fixed contact spring R2) or a third switching channel between the pads P0 and P3 (through the fixed contact spring R3), and this can be done depending on the vertical force F1, F2 or F3 that is applied to the drum 36 by the user.

The common star-shaped trigger member 30 (FIG. 15), here made of metal, combines four trigger branches each of which consists of a trigger branch Bi, of generally radial orientation, which extends outwards from a central portion 80 of generally domed shape and whose concavity is oriented vertically upwards.

The four branches Bi are identical and distributed angularly at 900 so that the member 30 has a symmetry of design about its central vertical axis which, in position mounted in the casing, corresponds to the intersection of the planes PLM and PTM.

The bottom of the central part 80 of the star-shaped trigger member forms an upstep 82 whose concavity is oriented downwards in order to rest on the ball 28 (see FIG. 15) and to allow slight pivoting movements of the star-shaped member 30 about the center of the ball 28.

The member 30 comprises two diametrically opposed longitudinal branches, left B2 and right B3, which are called second trigger branch B2 and third trigger branch B3 and which belong in particular to the second and third switching channels respectively.

The member 30 also comprises two first transverse trigger branches B 1 (FIG. 8) which are diametrically opposed, and able where appropriate to belong to the first switching channel.

These two branches B1 also serve for the positioning of the member 30 in the cavity of the lower casing 22.

Each trigger branch Bi extends slightly upwards and their free ends are substantially coplanar.

In the mounted position of the trigger member 30 (FIG. 15), and in the high rest position of the drum 36, each free end 86, 88 of the branch B2, B3 extends over and at a distance vertically from the coil 16, 18 at the top end of the associated contact spring R2, R3.

In the same manner, each free end 90 (FIG. 16) of the branch B1 (front, rear) extends over and at a distance from the top end coil 27 of the associated fixed contact spring R1 when such springs R1 are present.

As can be seen in particular in FIG. 15, the control member, or drum 32 rests vertically on the upper convex faces of the free ends 86 and 88 of the longitudinal trigger branches B2 and B3. The latter are slightly elastically prestressed downwards by a value Fp and they thus provide an elastic return function of the drum 36 to its high rest position illustrated in the figures in which the longitudinal end sections 44 and 46 are pressing upwards against the upper bottoms of the complementary recesses 51, 53 formed in the lower face 55 of the cover 26.

In this position, the O-rings 45 and 47 are slightly elastically compressed and they perform a function of damping impacts and vibrations when each end 44 or 46 returns in the upward direction to the high rest position, and in particular in order to prevent interference noise.

As a variant not shown, the O-rings 45 and 47 may be overmoulded around the sections 44 and 46 and/or made by bi-material moulding.

The noise damping function is very important insofar as, when the user begins to cause a change of state of the member 30 by pressing on the drum, the triggering in the direction of closing one or more contacts (or “collapsing”) cannot be stopped and the assembly acquires a very great speed and a great force of maximal impact. The same applies during the release or opening with corresponding upward movements.

When the drum or roller 36 (FIG. 15) is rotated, the tracks 41, 43 near opposite ends of the drum 36 slide on the upper faces of free ends 86, 88 of the trigger member 30. The design of the member 30 and of its branches Bi is such that, when the free ends of two diametrically opposite branches Bi are acted upon by applying a substantially vertical downward force, the branches initially deform elastically. Then the opposite branches suddenly change position to incline downwards. This sudden change is used to provide a trigger function in order to establish the corresponding switching channel and also providing a tactile and/or auditive “click” sensation of the sudden change of position. In the preferred design of the member 30, all four branches Bi change state simultaneously to incline downwards.

The use of the second “LEFT” switching channel will now be described from the rest position illustrated in the figures.

When the user applies a vertical force F2 (FIG. 1), that is to say that he presses on the left on the drum 36 (FIG. 15), he causes a lowering or descent of the corresponding left end 44 of the shaft. The shaft tilts about a transverse horizontal axis (orthogonal to the axis X-X) passing through the point of contact of the right end cylindrical section 46 of the shaft with the cover 26. As a result, the free end 86 of the trigger member branch B2 comes into electrical contact with the top coil 16 of the contact spring R2, as illustrated in FIG. 24. This establishes the second electric switching channel (through parts P0, 28, B2, 86, R2, P2) between the terminals C0 and C2 via the common trigger member 30 which is conductive and which, via its central part, is always in electrical contact with the central fixed contact 28-P0 which is common to the first three switching channels.

In symmetrical manner, the application of the force F3 by pressing on the right on the drum is used to produce a signal or pulse thanks to the third “RIGHT” switching channel (28-P0, B3, 88, R3, P3) between the terminals C0 and C3, as illustrated in FIG. 23.

When the user applies the vertical force F3, that is to say that he presses on the right on the drum 36, he causes a lowering or descent of the corresponding right end 46 of the shaft which tilts about a transverse horizontal axis (orthogonal to the axis X-X) passing substantially via the point of contact of the upper face of the left end cylindrical section 44 of the shaft with the upper bottom of the housing 51 of the cover 26.

For the use of the first “SELECT” electric switching channel, the user applies the force F1 substantially in the centre 38 of the drum. This causes a general lowering or vertical descent of the control member 32 with the axis X-X which remains generally horizontal and parallel with itself, this movement being guided virtually without clearance by the slots 48 and 50 (FIGS. 15 and 25) and the O-rings 45 and 47. The cylindrical tracks 41 and 43 of the drum 36 then act simultaneously and symmetrically on the two longitudinal branches B2 and B3.

Due to this “balanced” deformation force, and through the design of the common trigger member, the four branches Bi again change state simultaneously.

Since there is virtually no pivoting of the trigger member 30 relative to the ball 28, the free ends 86 and 88 of the two longitudinal branches B2 and B3 come virtually simultaneously into contact with the top coils 16, 18 of the springs R2 and R3. It is therefore possible, thanks to a software program associated with the device 20 for the analysis of the signals or pulses produced for the different channels, to distinguish this situation corresponding to the virtually simultaneous formation of signals on the second and third channels from the situation corresponding to the consecutive application of forces F2 then F3 (or F3 then F2) which culminates in a much greater time difference between the two associated signals. The first switching channel corresponding to the application of the force F1 is established and detected in this way.

In versions with five switching channels (with four springs R1, R1, R2 and R3) or with three switching channels (with only two springs R1), the two branches B1 which descend come, via their free ends 90, 92, virtually simultaneously into contact with the top coil 27 (FIG. 16) of the fixed contact spring R1 opposite it. The design according to the invention thus makes possible another method of detecting the establishment of the first switching channel when F1 is applied.

In the embodiment shown, the “duplication” of the branches B1 and the pads P1 is redundant, insofar as the sudden change of state of the two branches is virtually simultaneous, but this redundancy provides a large degree of security of operation.

According to the invention, thanks to a greatly reduced number of components and by means of the single manual control member 32 in the form of a drum 36, the elastic return of the drum to the rest state, the switching of the “LEFT”, “RIGHT” or “SELECT” channels in distinctive manner by acting on the distinct zones of the drum, and the tactile and/or auditive effect (“forth” and “back”) for each of these three channels are obtained.

A detailed description will now be given of five solutions or configurations allowing the switching of the “LEFT”, “RIGHT” and “SELECT” channels of a drum device with a minimum of components. These solutions provide: the elastic return of the drum to the rest state, the tilting of the drum to the left (“LEFT” channel), to the right (“RIGHT” channel), to the centre (“SELECT” channel) with this being done in distinct manners at the three defined zones along the length of the drum, and the electric switching of each of these three channels and the obtaining of a tactile and/or auditive (“forth” and “back”) effect for each of the three channels.

All these functions may be performed:
With four pieces (one common trigger member, two contact springs and one ball).
With six pieces (one common trigger member, four contact springs and one ball).
With two pieces (one common trigger member and one ball).
With one piece (one common trigger member).

It will be noted that the casing or body of the device comprises no mobile or articulated pieces, thus making it easy to use in the items of equipment that receive this type of device.

All the configurations (except that which uses only the single trigger member which does not offer the flexibility of the choice of configuration provided, during assembly, by the spring contacts) can be used to manufacture either devices with five channels, or devices with three channels by simply swapping or deleting (depending on the configuration) contact springs at the time of final assembly.

For a thorough understanding of how the common trigger member 30 interacts with the movements of the drum 36, a relative orthogonal reference mark V′, L′, T′will be used in which:
the origin O′ is the centre of the ball 28.
the axis L′ passes through O′ and is parallel to the axis X-X of the drum 36 of the single control member 32.
the axis V′ passes through O′ and is situated in the PLM plane.
the axis T′ passes through O′ and is situated in the PTM plane.

It will be noted that, relative to the reference V, L, T:
the origin O′ is fixed since the ball is fixed.
the axis T′ is fixed since it passes through a fixed point orthogonal to a fixed plane.
the axis L′ is mobile in the PLM plane since it is parallel to the axis X-X of the drum whose movements are situated in the single PLM plane due to the vertical guidance of the two longitudinal end sections 44 and 46 in the vertical slots or housings 48 and 50 of the casing.

Consequently, the only possible movements of the relative marking V′, L′, T′ relative to the fixed marking V, L, T are rotations about the fixed axis T′.

When the drum 36 is driven simply in rotation, with a force whose vertical component is less than the prestress Fp, the axis X-X of the drum remains immobile in its high position, the drum slides in rotation on the free ends 86 and 88 of the branches B2 and B3 of the trigger member 30, without “lowering” its longitudinal trigger branches B2 and B3. None of the “SELECT”, “RIGHT” or “LEFT” switching channels is therefore used.

The design of the trigger member 30 and of its branches Bi is such that, when the free ends of the two diametrically opposed branches Bi are acted upon by applying a substantially vertical downward force in the marking in which the member 30 is placed, the branches deform elastically until they reach a deformation with a value tc (called a sudden change of state or “collapsing”), then they suddenly change position to incline downwards.

This sudden change or collapsing of the member 30 is used to perform a trigger function in order to establish the switching channel corresponding to the angular position of the relative marking V′, L′, T′ relative to the fixed marking V, L, T and also provides a tactile and/or auditive “click” sensation of the sudden change of position.

Through the preferred design of the common trigger member 30, and although only its two diametrically opposed branches are mechanically acted upon, all the branches Bi simultaneously change state to incline downwards with an identical substantial lowering. The two branches B1 which are not acted upon mechanically by the drum 36 are received with a slight clearance in two complementary recesses of the casing to provide the positioning and angular orientation of the trigger member 30, both in the fixed marking V, L, T and in the relative marking V′, L′, T′.

First configuration using the two contact springs R2 and R3 and the ball 28 It will now be described how the second “LEFT” switching channel is used from the rest position of this first configuration.

When the user applies the vertical force F2, greater than the prestress Fp existing in the rest state, that is to say when he presses on the left on the drum 36 (FIG. 15), beyond the level of the left end of the branch B2 of the member 30, he causes a lowering or descent of the corresponding left end 44 of the shaft, until it comes up against the bottom 48 of the casing, while the opposite longitudinal end 46 remains in the high position pressing on the upper bottom 53 of the cover 26.

The axis X-X of the drum therefore undergoes a rotation through angle α in the counterclockwise direction (relative to the plane of FIG. 24, for example) about a transverse horizontal axis (orthogonal to the PLM plane) passing substantially through the point of contact 46 of the upper face of the smaller diameter right end cylindrical section 46 of the shaft with the upper bottom of the housing 53 of the cover 26.

The relative marking V′, L′, T′ also pivots through the same angle α about its axis T′ relative to the fixed marking V, L, T.

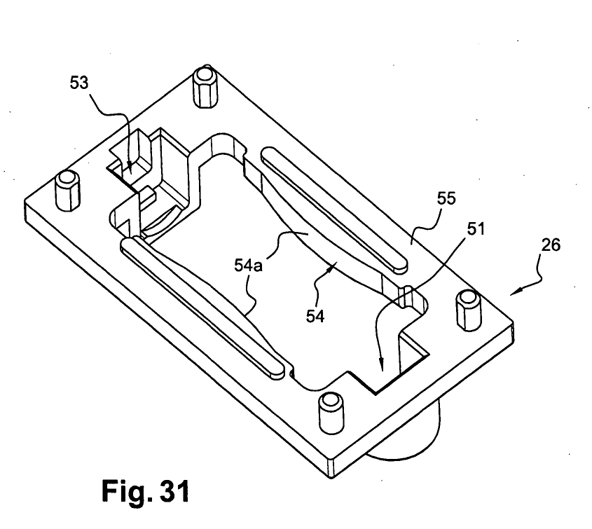

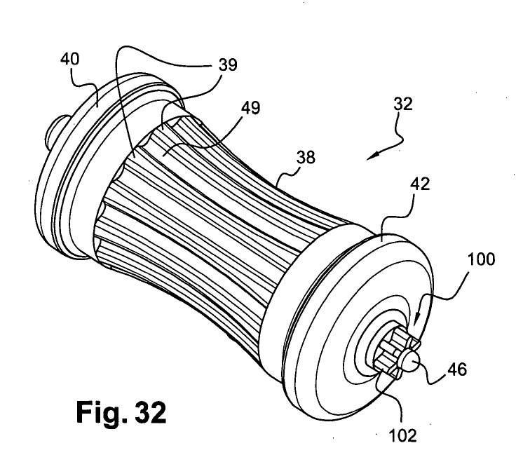

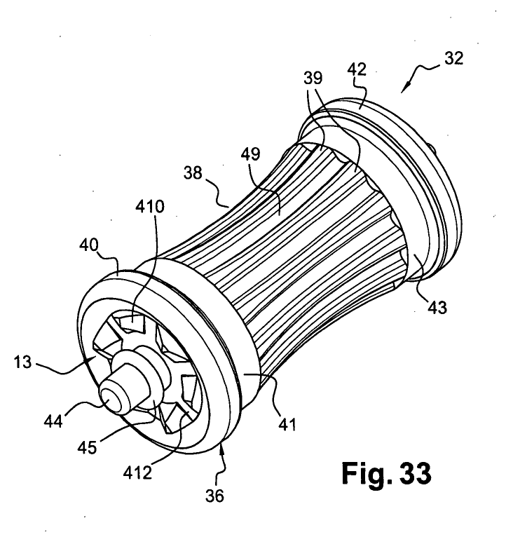

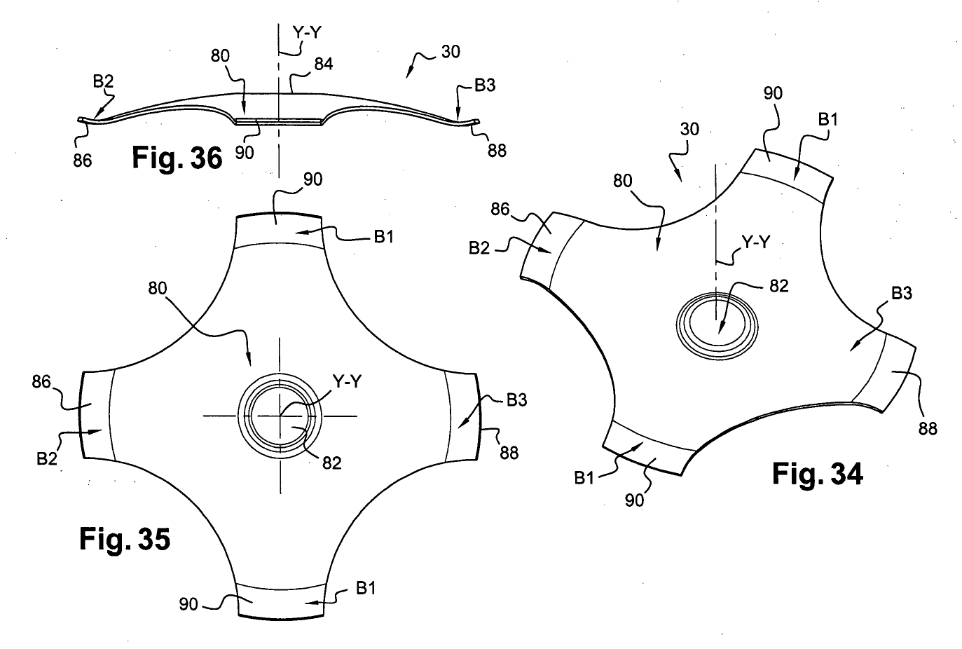

The trigger member 30 (FIG. 15) follows in rotation the movement of the relative marking V′, L′, T′ thanks to a slight rolling of the concave housing 82 in its central portion 80 on the top of the ball 28. The fact that a ball 28 is present between the pad P0 and the central portion 80 of the trigger member 30 is used to cause the rolling of a “standard” dome trigger member which usually comprises a flat-bottomed or hemispherically-bottomed central portion (called a “dimple”) projecting upwards, as shown in FIGS. 34 to 36.

Because the ratio d/l of the distance “d” (between the ball 28 and the axis X-X) over the length “l” (between the longitudinal ends 44 and 46 of the drum) is markedly less than 1, the relative sliding of the drum 36 relative to the trigger member 30 along the axis L′ of the marking V′, L′, T′ (due to the rotations of these two members about different axes) is very slight and it is allowed by the slight clearance existing between the trigger member branch free ends 86 and 88 and the sections 40 and 42 on the cylindrical annular tracks 41 and 43.

Thus, by placing itself in the marking V′, L′, T′, the drum has sustained a translation t′₂ downwards along the axis V′ and a slight translation ε′₂ from left to right in the direction L′. The latter translation is absorbed by the clearance described hereinabove and it produces no effect on the trigger member 30.

On the other hand, the translation t′₂ causes in the relative marking V′, L′, T′, an equivalent vertical lowering t′₂ of the ends of the branches B2 and B3 of the trigger member 30.

When the lowering value t′₂ exceeds the “collapsing” value tc, the trigger member 30 changes state and the lowering of the end 44 of the drum continues suddenly as far as t′_{2 max} coming up against the bottom of the slot 48 of the casing. Thus, when the “collapsing” is triggered, there is no longer any position to stop the lowering between the position t′₂=t_{c} and the position t′_{2 max}.

In the relative marking V′, L′, T′, the maximal lowering value t′_{2 max} is identical for the two ends of the free branches B2 and B3 of the trigger member 30.

On the other hand, in the fixed marking V, L, T, the lowering value t_{2 max b2} of the end of the branch B2 is very clearly greater than the lowering value t_{2 max b3} of the end of the branch B3.

Specifically, the lowering t_{2 max b2} is the result of the combination of t′_{2 max} and the rotation α directed downwards, while the lowering t_{2 max b3} is that of the combination of t′_{2 max} and the rotation α directed upwards.

As an example shown in FIG. 24, we have t_{2 max b2}=0.25 mm and t_{2 max b3}=0.07 mm.

These values are substantially in the ratio of the distances between the contact point P46 and the intersections of the vertical axes of the contact springs R2 and R3 with the axis X-X.

The length or height of the springs R2 and R3 is such that, in the rest state, the distance dr between their top coils and the free ends of the branches B2 and B3 of the trigger member 30 is less than t_{2 max b2} and greater than t_{2 max b3} in order to switch the LEFT channel and not switch the “RIGHT” channel when the force F2 is applied to the left end of the drum.

This establishes the second electric switching channel (28-P0, B2, 86, R2, P2) between the terminals C0 and C2 through the common member 30 which is conductive and which, via its central part 80-82-84, is always in electrical contact with the central fixed contact 28-P0 which is common to the first three switching channels.

In symmetrical manner, the application of the force F3 by pressing on the right of the drum is used to produce a signal or a pulse by means of the third “RIGHT” switching channel (28-P0, B3, 88, R3, P3) between the terminals C0 and C3, as illustrated in FIG. 23.

When the user applies the vertical force F3, that is to say that he presses on the right on the drum 36, he causes a lowering or descent of the corresponding right end 46 of the shaft which tilts about a transverse horizontal axis (orthogonal to the axis X-X) passing substantially by the point of contact P44 of the upper face of the left end cylindrical section 44 of the shaft with the upper bottom of the housing 51 of the cover 26.

To use the first “SELECT” electric switching channel, the user applies the force F1 substantially in the centre 38 of the drum.

He thus causes a lowering or generally vertical descent of the control member 32 with the axis X-X which remains generally horizontal and parallel with itself, this movement being guided by the slots 48 and 50 (FIG. 25) and the O-rings 45 and 57.

The cylindrical tracks 41 and 43 of the drum 36 then act simultaneously and symmetrically on the ends of the two longitudinal branches B2 and B3.

Because of this “balanced” deformation force, and through the design of the common trigger member 30, the four branches Bi again change state simultaneously.

The angle α remaining substantially equal to 0 (zero), the relative marking V′, L′, T′ remains the same as the fixed marking V, L, T and this gives: t′_{1 max}=t_{1 max b2}=t_{1 max b3}.

In the example shown in FIG. 25, this gives for example t_{1 max b2}=t_{1 max b3}=0.35 mm.

This value being greater than the distance dr, and insofar as it produces virtually no pivoting of the trigger member 30 relative to the ball 28, the free ends 86 and 88 of the two longitudinal branches B2 and B3 come virtually simultaneously into contact with the top coils 16, 18 of the springs R2 and R3. Thus it is possible, thanks to a software program associated with the device 20 for the analysis of the signals or pulses produced for the various channels, to distinguish this situation corresponding to the virtually simultaneous formation of signals on the second and third channels from the situation corresponding to the consecutive application of forces F2 then F3 (or F3 then F2) which culminates in a much greater time difference or gap between the two associated signals.

Thanks to the phenomenon of sudden change of state of the member 30, when the latter “collapses”, the user who presses on the drum to switch a channel can no longer slow the lowering travel of the branches of this member 30. The maximal time difference between the establishment of electric contacts of the branches B2 and B3, with the top coils of the springs R2 and R3, when “SELECT” is pressed, is therefore very slight—of the order of 20 ms—and this is irrespective of the user.

The variation of this time difference, between 0 and 20 ms approximately, is related to the production tolerances of the pieces and of the pressing position in the central zone 38 of the drum. It is humanly possible to switch the second channel then the third channel consecutively, or vice versa, in such a brief time.

The first switching channel corresponding to the application of the force F1 is therefore established and detected in this way.

Second configuration using the four contact springs R1, R1, R2 and R3 and the ball 28.

The design according to the invention also allows another method (not shown) of detecting the establishment of the first switching channel when F1 is applied.

The two branches B1 which lower simultaneously with the branches B2 and B3 come, via their free ends 90, virtually simultaneously into contact with the top coil 27 of the additional contact springs R1.

During the “LEFT” and “RIGHT” pressurings, represented in FIGS. 23 and 24, the lowering of the branches B1 (which is substantially equal to those of the branches B2 and B3 in the relative marking V′, L′, T′) is, in the fixed marking V, L, T, equal to the arithmetic average of the lowerings t_{2max b2}/t_{2max b3} (or t_{3maxb2}/t_{3max b3}), that is: (0.07+0.25)/2=0.16 mm.

When “SELECT” is pressed, the lowering of the ends of the branches B1 is substantially equal to that of the ends of the branches B2 and B3, or, as in the example shown in FIG. 25, equal to 0.35 mm.

It is therefore possible to choose a length or height of the springs R1, slightly less (for example approximately 0.1 mm) than that of the springs R2 and R3 so that the ends of the branches B1 of the trigger member 30 come into contact with the top coil 27 of the springs R1 when the force F1 is applied, and do not come into contact when the force F2 or the force F3 is applied. Naturally, in this second configuration, the pads P1 of the overmoulded fixed contact must be independent of the pads P2 and P3 and be connected to additional outputs C1 and C1′ (distinct or the same in order to provide, or not provide, a redundancy used to increase the security of operation of the “SELECT” function).

This second configuration (not shown) avoids the use of the software program associated with the first configuration, but it causes an increase in the number of pieces or components (four contact springs instead of two) and in the number of contact outputs on the printed circuit board which receives the device.

Third configuration using the two contact springs R1, R1 and the ball 28.

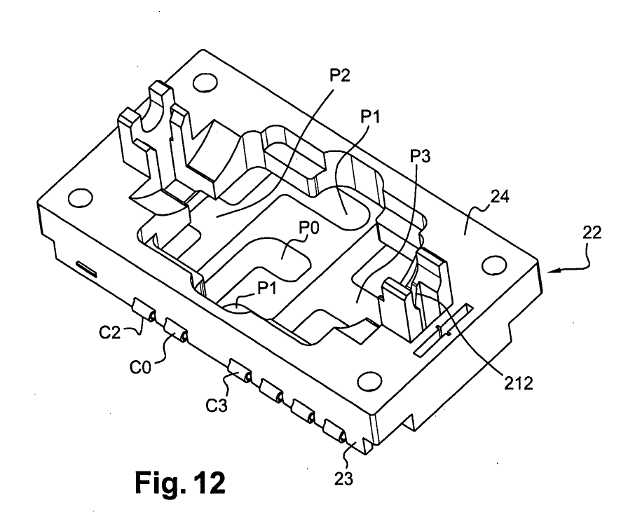

The design according to the invention allows a third configuration corresponding to a control device with a drum and with three switching channels: “SELECT”, “DOWN” and “UP”. In this third configuration, the spare parts are identical to those of the first configuration, except for the contact springs R2 and R3 (resting on the pads P2 and P3) which are removed and replaced by the two contact springs R1 of the second configuration (resting on the pads P1, FIG. 12).

Thus, irrespective of the pressing force (F1, F2 or F3) applied to the drum, it is the “SELECT” switching that will be used. It is to standardize the overmoulded casing on the fixed contact grid that the pads P1 are respectively connected to the pad P2 for the first, and to the pad P3 for the second, as shown for example in FIG. 14.

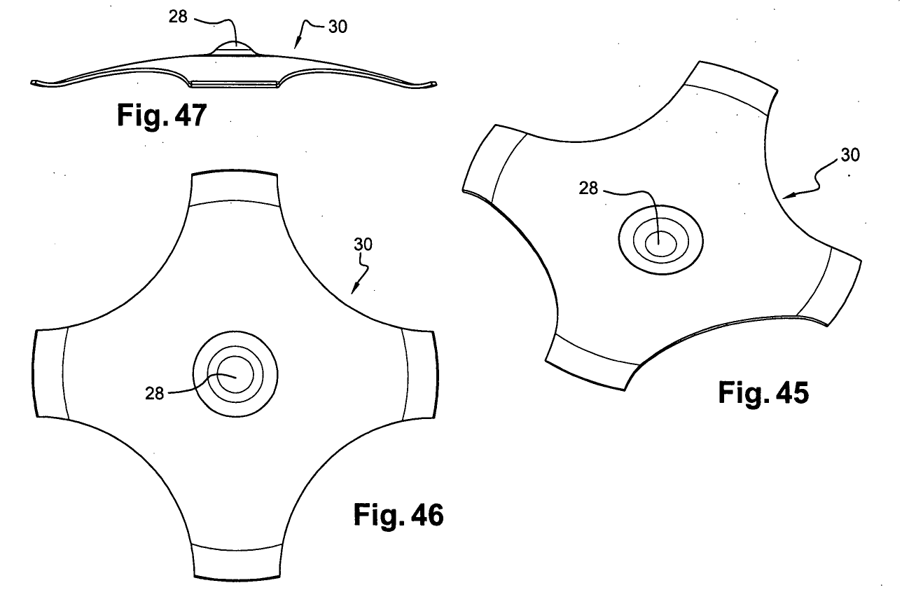

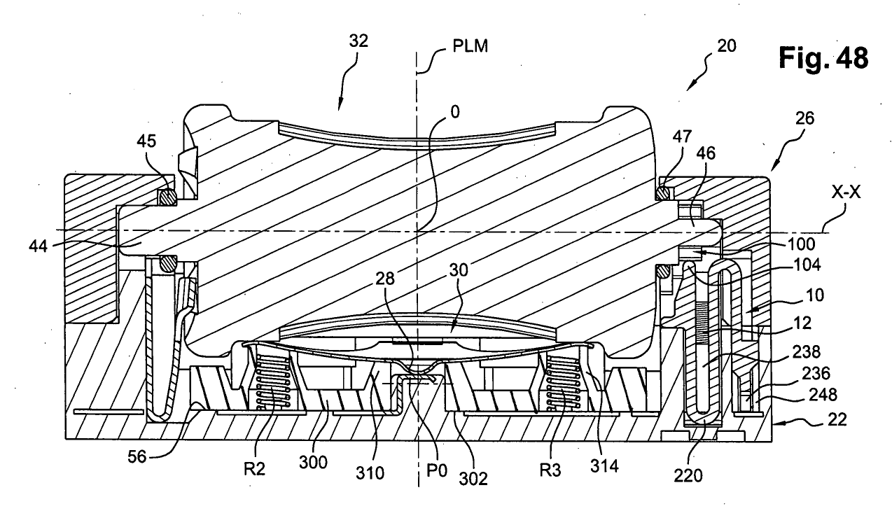

Fourth configuration using the two contact springs R2 and R3 and no ball 28. The design according to the invention allows a fourth configuration represented in FIG. 48 in which the ball 28 is removed and replaced by a portion in relief or hemispherical “dimple” 28 which projects vertically downward, that is made from the same die-stamping with the central portion 80 of the trigger member 30, as shown in FIGS. 45 to 47.

This die-stamped element or “dimple” ensures, when the drum pivots, a rolling function of the trigger member 30 on the pad P0 of the overmoulded contact grid.

The origin O′ of the relative marking V′, L′, T′ is then the centre of the hemispherical form of the die-stamping 28. The pad P0 may be advantageously raised, by stamping/cambering, relative to the plane of the contact grid, and overmoulded in a cylindrically-shaped nipple in order to retain the sealing function of the die-stamped electric contact 28-P0 inside the central recess of the seal 34.

To help the trigger member 30 to centre on the pad P0, the latter may have an upward-oriented concave form interacting with the convex form of the downward-oriented die-stamping.

Fifth configuration without contact springs and without the ball 28.

The design according to the invention allows a fifth configuration, shown in FIG. 51, in which the contact springs and the ball 28 are all removed. When the pressing forces F1, F2 or F3 are applied, the free ends of the branches B2 and B3 (and where necessary the branches B1) of the trigger member 30 then come directly into contact with the respective pads P2, P3 (and where necessary P1) which can be advantageously raised, by stamping/cambering, relative to the plane of the contact grid, and overmoulded in a cylindrically-shaped nipple in order to retain the sealing function of the electrical contacts inside the elastically deformable cones of the seal 34.

Naturally, in this configuration, the drum is stopped, when “LEFT”, “RIGHT” or “SELECT” are pressed, by the free ends of the branches of the member 30 coming directly into contact on the pads Pi of the overmoulded contact grid, the O-rings 45 and 47 serving as dampers to reduce the impact and thus minimize the wear of the contact zones, whose service life (in this configuration which comprises the minimum number of pieces) will be shorter than that of the solution with contact springs. The depth of the vertical slots or housings 48 and 50 of the casing is also slightly increased to avoid a hyperstatic phenomenon with the stopping of the branches on the pads.

Naturally, many combinations between the various configurations can be envisaged.

Because of the relative dimensions of the various components and their arrangement, the application of a substantially vertical force F1 at any point of the concave central part 38 of the drum allows the establishment of a “SELECT” type signal. This is inherent in the design according to the invention which allows the user to use the entire central zone 38 as a zone for applying a force F1 without necessarily targeting the “middle” of this zone.

On the other hand, the application of a vertical force on one of the ends, of type F2 or F3, outside the concave central zone 38 cannot result in the inopportune formation of a “SELECT” signal, but only in the formation of a “LEFT” or “RIGHT” signal.

The values 0.07 mm, 0.25 mm and 0.35 mm correspond to an inclination α=1°25 of the axis X-X of a drum 36 that is 11.5 mm long. These differences may be increased proportionally with the angle α and the length of the drum.

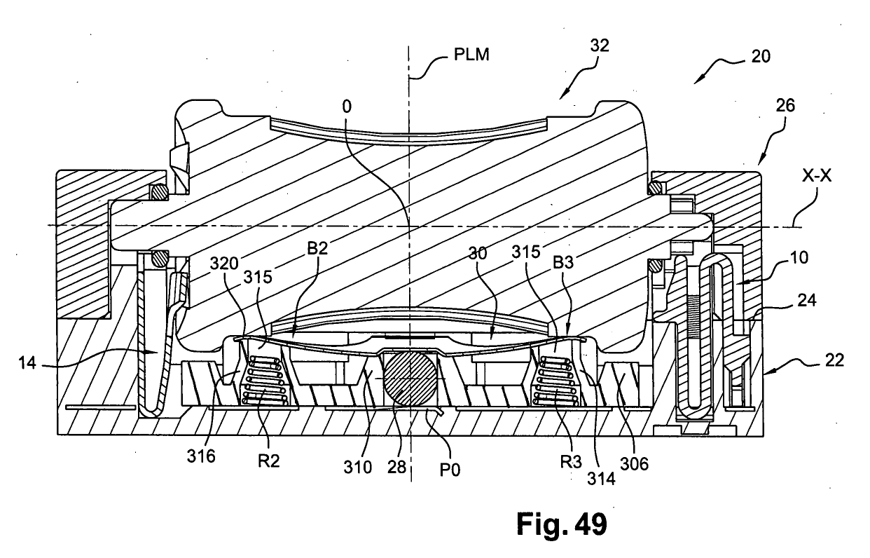

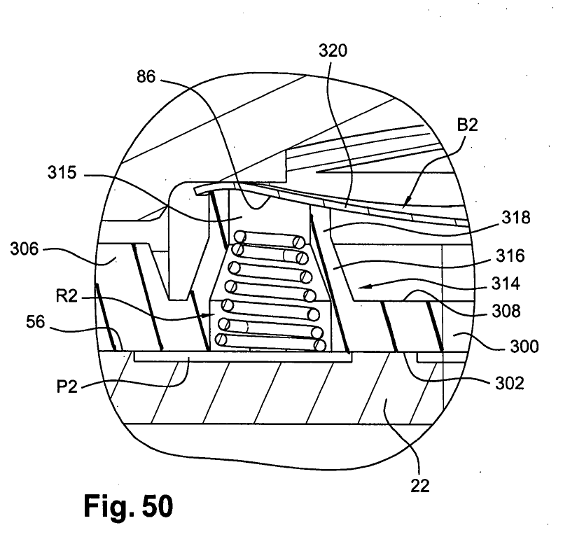

The force F1 is approximately 1.5 times greater than the forces F2 and F3. It is remarkable to obtain this ratio, which corresponds to that usually expected by the market, with a single trigger member. This result is intrinsic in the design of the invention and it is further enhanced by a “SELECT” stroke that is longer than the “LEFT” and “RIGHT” strokes. The tactile sensation is more sensitive to the variations of strokes than to the variations of forces. The contact springs are advantageously of conical form, as shown in FIGS. 49 and 50, for better vertical stability and to prevent their possible movements in vertical translation in the rest state when the device is subjected to vibrations or impacts in the direction V.

The signal generator 52 will now be described. Its general design is that described and shown in documents WO-A-02/075641 and WO-A-04/024423 and in the French patent applications No. 0211394 of 13 Sep. 2002, No. 0306475 of 28 May 2003, No. 03.06972 of 11.06.2003 and in the International patent application No. PCT/EP04/051095 of 11.06.2004.

The generator 52 (FIG. 19) comprises a straight toothed control gearwheel 100 which is rotatably connected to the central shaft of the drum and which is arranged between the portion of the end section 46 (FIG. 15) which supports the O-ring 47 and its smaller diameter free end portion.

Between two consecutive teeth 102 (FIG. 19) of the gearwheel 100, which here is a gearwheel with six teeth 102, an upper section 104 of the mobile contact element 10 in the rest position is received in order to cause the mobile contact element 10 to tilt in one direction or the other (F4, F5, FIG. 1) when the gearwheel 100 is rotated by the drum 36 to establish an electric contact between a lower section 220 (FIG. 19) of the mobile contact element 10 and one or other of the two fixed contact pads P4, P5 and thus generate a control signal, then cause the upper section 104 to escape automatically out of the space 140 formed between the two consecutive teeth, beyond a determined angle of rotation of the gearwheel.

According to the teachings of the invention, the mobile contact element 10 is an element made of stamped metal sheet all of whose stems, when at rest, extend in the plane of the metal sheet, here in the vertical longitudinal mid-plane PLM.

As can be seen in the figures, and particularly in FIGS. 27 to 29, the mobile contact element 10 consists essentially of three adjacent stems of generally vertical orientation, that is to say from left to right when considering FIG. 28, a main control and contact stem 200, an intermediate elastic return stem 202, and a free end stem 204 for attachment and installation.

The design of the mobile contact element 10 is such that the main stem 200 is mounted generally tilting about a horizontal tilting axis Z-Z which is parallel with the axis X-X.

The main stem 200 is in the form of a band of metal sheet of substantially constant width which comprises, above the tilting axis Z-Z, an upper section 104 and, below the axis, a lower section 206.

In the mounted and assembled position, the two sections, upper 104 and lower 206, are vertically aligned under the toothed gearwheel 100 as indicated in FIG. 23 so that the free end of the upper section 104 is received between the consecutive teeth 102 of the gearwheel 100.

At the tilting axis Z-Z (FIG. 28), the main stem 200 comprises a horizontal articulation branch 208 which extends horizontally towards the left opposite the intermediate stem 202 (in the vertical plane PLM) and which is intended to be received in the bottom 210 (FIG. 23) of a V-shaped slot 212 open vertically upwards and formed in the lower part of the casing 22. The branch 208 helps position the main stem in its initial position.

Above the axis Z-Z (FIG. 28), the upper section 104 of the main stem 200 comprises a greater width so as to be more rigid.

The intermediate stem 202 comprises a first vertical section 214 which extends over the whole height of the element 10 and whose lower end 216 is connected to the lower end 218 of the lower section 206 of the main stem 200, via a lower elbow 220 in a 180° arc.

The intermediate stem 202 comprises a second vertical section 222 whose upper end 224 is connected to the upper end 226 of the first section 214, via an upper elbow 228 in a 180° arc.

The lower end 230 of the second section 222 is situated above the tilting axis Z-Z.

Beyond the lower end 230 of the second section 222, the intermediate stem 202 is extended by the free end stem 204 which comprises a broadened intermediate part 232.

Beyond its lower end 234, the free end stem 204 comprises a transverse branch inclined and dished relative to the general vertical plane of the element 10 which constitutes a foot 236 resting on a conductive pad P6 (FIG. 15) connected to an output C6.

The sections 206 and 214 (FIG. 28), with the lower elbow 220 which connects them, are housed in a vertical housing 238 (FIG. 15) of the lower casing 22 which is formed by two opposing vertical walls 240 (FIG. 19) and into the lower part of which the pads P4 and P5 project.

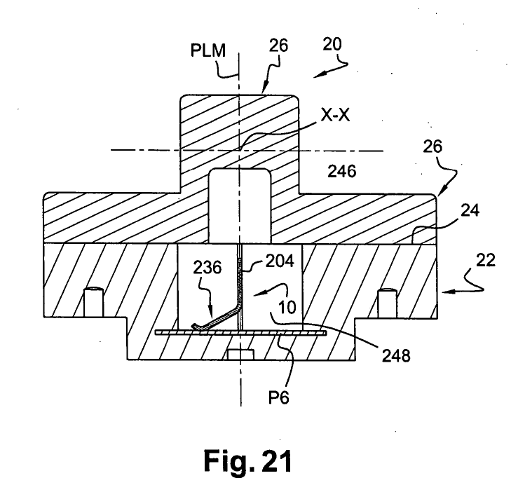

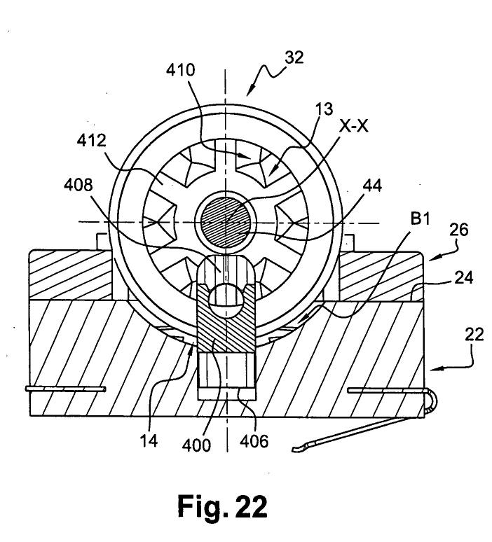

It is the lower end of the lower section 206 with the lower elbow 220 which is received between the pads P4 and P5 as can be seen for example in FIGS. 19 to 23.

In order to provide the vertically upwards closure, and the sealing of the housing 238, the anti-rebound damping element 12 (FIG. 19) is split in a vertical plane at its two opposite axial ends by two slots 250 in which are received corresponding portions of the first vertical section 214 and of the second section 222, on the axis Z-Z, and the longitudinal end sections of the damper 12 are received without clearance in complementary housings of the casing 22.

Advantageously, the sealing and damping block 12 is arranged substantially on the tilting axis of the mobile contact element 10, that is to say in a zone of the latter that is subject to the least substantial movements in the horizontal plane.

Above the axis Z-Z, the upper parts of the sections 214 and 222, with the elbow 228 that connects them, are received in a complementary cavity 246 (FIG. 24) of the casing 22 and of the cover 26.

The width in the transverse direction of the housing 246 is sufficient to allow angular deflections of the portions of the elements 10 that it receives.

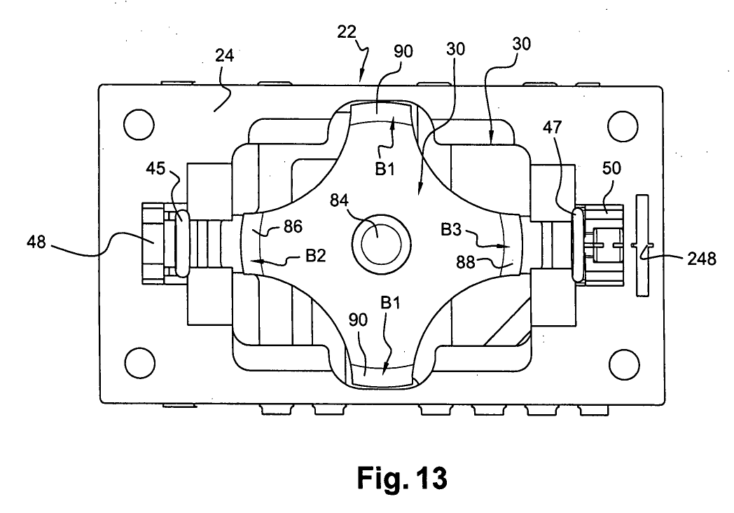

The free end stem 204, 232 which extends beneath the tilting axis Z-Z is inserted vertically into a slot 248 (FIG. 13), for mounting and attachment, with its lower inclined foot or branch 236 which rests on and is in permanent electric contact with the contact pad P6 arranged in the bottom.

The enlarged intermediate part 232 is forcibly inserted and it comprises forked ties or spurs 233 which immobilize the element 10 vertically.

The section 204, and therefore the mobile contact element 10 are thus permanently connected to the pad P6.

The free end stem 204, 232 also provides the installation and attachment of the element 10 in the casing 22 so that, by interacting with the horizontal branch 208, it allows a tilting of the main stem 200 in the directions about the axis Z-Z, while performing an elastic return function for the stem 200 in the vertical plane with the upper free end of the upper section 104 between two teeth when at rest as illustrated for example in FIG. 19.

The elastic return function is performed by the intermediate return stem 202. The S shape of the mobile contact element 10 (FIG. 28) provides sufficient elasticity in a very small space, particularly in the longitudinal direction of the device. The compactness of such an S-shaped contact element 10 is used to minimize the space requirement of the browser, to make it easier to seal against dust, and also make it easier to produce by stamping in long production runs without smoothness problems, which is a crucial factor to ensure that the shape of the signals produced by the generator is even and symmetrical in “UP” and in “DOWN”.

The damper block 12 obstructs in sealing manner the upper entrance of the cavity 238 (FIG. 19) in which the pads P4 and P5 are housed, while thus preventing any ingress of dust harmful to the electric contacts coming from outside the device, or wear by friction between the various pieces and components moving inside the device 20.

Through its damping function, the block 12 retards the return speed of the mobile contact element 10 towards its vertical balanced position, after it has undergone an angular deviation by electric deformation during each passage of a tooth 102 of the control gearwheel 100 of the control member 32.

The damping effect provided by the block 12 prevents the risk of violent oscillation(s) of the element 10 about its balanced position, between two consecutive passes or clearances of teeth 102 which could cause interference rebounds on the contact pad opposite the one on which the lower elbow 220 establishes a string of electric pulses corresponding to the direction of rotation of the drum 36.

The presence of the damper block 12 helps to simplify the software for analysing the signals by providing no function for distinguishing the interference signals resulting from the rebounds.

A description will now be given in detail of the piece 34 (FIG. 2) for guiding and retaining the contact springs Ri and the ball 28 which is also a piece forming a sealing block for the various corresponding electric contact zones.

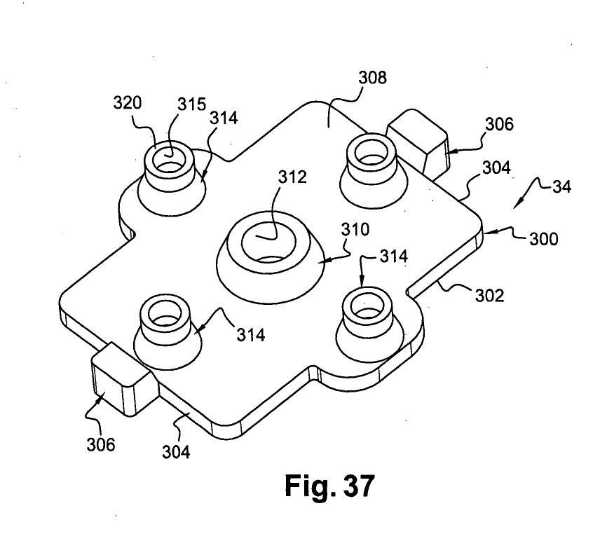

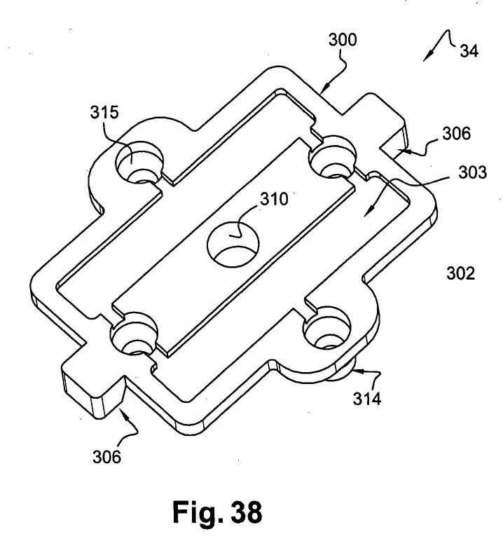

As can be seen in particular in FIGS. 37 and 38, the piece 34 is a piece moulded in flexible material, for example natural or synthetic elastomer material.

It comprises a lower horizontal bedplate 300 whose partially recessed lower face 302 rests in sealing manner against the bottom 56 (FIG. 2) of the lower casing 22.

The lower bedplate 300 (FIG. 37) has a rectangular contour and is of symmetrical design relative to its two vertical longitudinal and transverse mid-planes.

In each of its transverse end edges 304, the bedplate 300 comprises a heel 306 which extends vertically upwards beyond the upper horizontal face 308 of the bedplate 300 and which constitutes a block for abutment and impact damping for the ends 40 and 42 of the drum 36 when the latter is caused to tilt by applying a force F1, F2 or F3.

In its central part, the bedplate 300 comprises an upper tubular extension 310 whose internal vertical through passage 312 receives the metal ball 28 which it positions at right angles and above the central contact pad P0.

The positioning of the piece 34 is provided by the shapes of the bedplate 300 which is received in complementary hollow forms of the lower cavity formed in the bottom of the casing 22.

Each contact spring is received in a frustoconical tubular extension 314 with a through passage which is made, like the extension 310, of the same material and in one piece by moulding with the bedplate 300.

Thus, the piece 34 comprises four tubular extensions 314 distributed in pairs in the vertical, longitudinal and transverse mid-planes of the piece 34, and symmetrically either side of the central tubular extension 310 which receives the ball 28.

All the tubes or tubular extensions 314 for the housing of the contact springs (R1, R2 or R3) are indicated by the same reference numbers.

As can be seen for example in greater detail in FIG. 50, according to a preferred embodiment, each tubular extension 314 comprises a frustoconical intermediate section 316 which extends above the upper face 308 of the bedplate 300 and a cylindrical tubular upper free end section 318.

The dimensions and the design of the section 318 are such that its free end upper annular edge 320 supports a free end section 86 of a trigger member branch B2. The free end section 86 interacts with the edge 320 to close off the cavity 315 in the tubular extension 314 which houses the contact spring R2.

Insofar as the lower face 302 of the bedplate 300 also interacts in sealed manner with the bottom 56 of the lower casing 22, the cavity 315 is closed off in sealed manner at its two ends.

The total height of the housing 315 is naturally greater than the total height of the spring Ri that it receives so that, when at rest—that is to say in the absence of deformation action on the common member 30—there is no electric contact between the branch Bi and the associated pad Pi.

In addition to its function of positioning the ball 28 and the contact springs, the sealing piece 34 performs an individual sealing function for each contact assembly formed by a trigger member branch Bi and by a pad Pi with a spring Ri. The piece 34 also provides a seal at the electric contact of the ball 28 with the pad P0 (FIG. 15) and with the central part of the common member 30.

The originality of this arrangement is therefore the individual character of the sealing function from dust at each of the electric contact chains, thus making it possible to minimize the space to be protected against the ingress of dust originating from the contamination external to the device, or from the internal contamination resulting from the wear of the pieces and components by friction, as the device is increasingly used.

The flexibility of the elastomer material of which the piece 34 is made allows its lower face 302 to seal against the horizontal lower face 56 of the casing 22. Also, the upper annular face of each of its tubular extensions seals against corresponding portion of the common trigger member 30.

The flexibility of the elastomer material and the frustoconical shape of the tubular extensions 314 are determined so as “to follow” the rotary movements and the elastic deformations of the trigger member 30, without detracting from the seal and without generating high reaction forces which oppose the sudden change of state of the trigger member 30.

As can be seen in FIG. 38, the lower face 302 of the sealing piece has a recess or a peripheral facing 303 which interconnects the housings 315 of the four tubular extensions 314 in order to form, in the assembled position, an “air chamber” sealed from dust.

Thus, the slight variations of internal air volume of the frustoconical tubular extensions 314 resulting from the various control actions on the common member 32 are compensated for (by the communicating vessels effect) by variations of opposing values of the large air volume of the chamber 303 whose thin upper horizontal wall may deform elastically.

Such a solution is used to avoid providing vents which would constitute possible entries for dust by aspiration.

The piece 34 also performs a function of damping the vibrations and hence the noises produced by the sudden changes of state of the common trigger member 30.

The O-rings 45 and 47 (FIG. 15) reduce noises produced during the downward pressings (and the upward releases) when a force F1, F2 or F3 is applied, by damping the impacts of the sections 44 and 46, on the one hand, on the bottom of the vertical slots 48 and 50 of the casing and, on the other hand, on the upper bottom of the housings 51 and 53 of the cover 26.

The dimensions of the O-rings and those of the casing housings in which they slide are such that, at the end of a pressing or release, the corresponding O-ring first comes to slightly collapse on the bottom of its housing before the corresponding longitudinal end section 44, 46 of the control member 32 finally stops against the bottom of the corresponding housing in the casing or the cover.

In order to mechanically protect the shaft end sections 44 and 46 against inopportune pressings of the user who could, by applying excessive forces F1, damage them or even break them, the cavity of the casing comprises, opposite each of the two end sections 40 and 42 of the drum 36, a cradle 252, 254 (FIG. 2) of cylindrical shape which forms a safety stop against the lowering of the drum.

The dimensions of these cradles 252 and 254 are determined so that such a stop occurs only after the longitudinal end section 44 of the control member 30 and/or the walls of the vertical slot 50 of the casing has undergone a slight elastic deformation, and naturally before the limit of this elastic deformation is reached.

The cradles 252 and 254 are furnished with a slot in their central part which receives the extension in the shape of the damper pad 306 (FIG. 37) of the sealing piece 34.

The pads 306 thus play the role of retarders and transitory dampers between the pressing of the longitudinal end sections of the control member 30 on the bottom of the vertical slots 48 and 50 of the casing, and the eventual safety stop of the sections 40 and 42 on their respective cradles 252 and 254.

This safety stop also allows the device to withstand without damage the drop tests which are carried out on equipment or apparatus receiving this type of device and which involve causing drops of approximately 1.5 m onto a concrete slab in turn on all the faces of the apparatus, including that in which the device is placed.

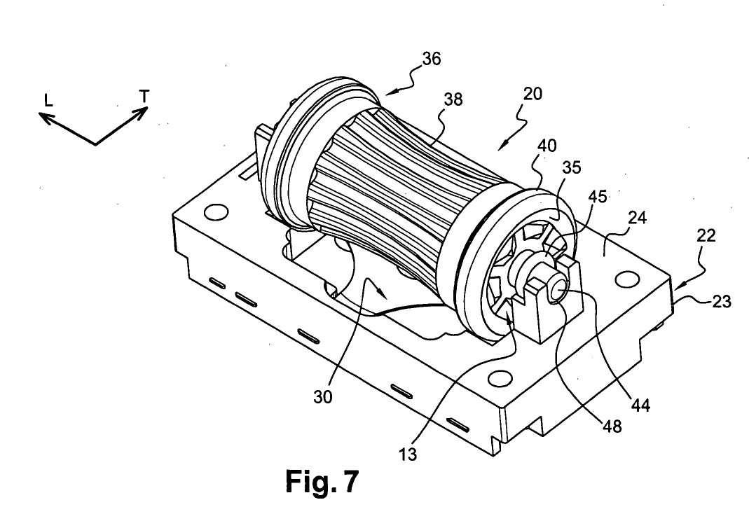

The control device 20 includes the elastic pawl 14 (FIG. 2) made of bent metal sheet and stamped and illustrated in detail in FIG. 40, which interacts with the associated ratchet-type toothed wheel 13 supported by the drum 36 and illustrated in detail in FIGS. 7, 22 and 33.

The pawl 14 (FIG. 40) comprises a vertical branch 400 for installation and attachment in a complementary slot (FIG. 8) of the casing, and a substantially vertical active branch 404 to which it is connected by a lower elbow 406 which gives the branch 404 its elastic deformation capabilities.

The upper free end section 408 of the active branch 404 of the pawl 14 has a convex domed profile oriented towards the wheel 13.

The wheel 13 here is made for example of the same material and in one piece by moulding in the left longitudinal end transverse face of the drum 36 and it comprises a series of housings 410, each of generally axial orientation, and which are separated from one another by shaped radial partitions 412.

The cavities 410 and the partitions 412 are equal in number to the number of teeth of the control gearwheel 100.

The ratchet wheel 13 is integral in rotation with the gearwheel 100 and, in each angular rest position of the control member 32, the boss 408 of the pawl 14 is received fitted elastically into a housing 410 of the wheel 13, while the section 104 of the mobile contact element 10 is received with clearance between two consecutive teeth 102 of the gearwheel 100.

The pawl 14 with the wheel 13 thus performs a first angular rest positioning function of the drum 32.

Furthermore, at the time of each rotation of the drum 36 in one or other direction, by applying a force F4 or F5, the user causes an elastic deformation of the pawl in order to cause the boss 408 to come out of the housing 410 that it occupied, the clearance of a partition 412 and then the return of the boss 408 into the consecutive housing.

The user thus perceives a tactile sensation of clearance and therefore of generation of a corresponding signal, and an auditive sensation when the boss 408, under the action of the elastic active branch 404, re-enters a housing 410.

The finger or boss 18 of the pawl 14 thus procures a sudden detent effect when it interacts successively with the housings 410 and the partitions 412 of the wheel 13.

Each housing 410 is advantageously formed by two opposing inclined lateral faces in order to form a V opening radially outwards, the inclination being of the order of 5° to 8°.

In combination with the shape and dimensions of the finger or boss 408, when the left end portion of the drum 38 descends vertically relative to the boss 408 (which for its part is fixed vertically), the V profile of the housing 410 in which the boss 408 is received supplies a return spring effect acting on the drum vertically and upwards to compensate for the friction forces of the pawl on the drum which pose no problem during the vertically downward pressing by the user's finger but which could compromise correct operation during the release because the sole upward return force is then that exerted by the member 30 (when the user's finger has relaxed the application of the downward force).

This elastic return effect is added to that exerted by the branches of the trigger member 30.

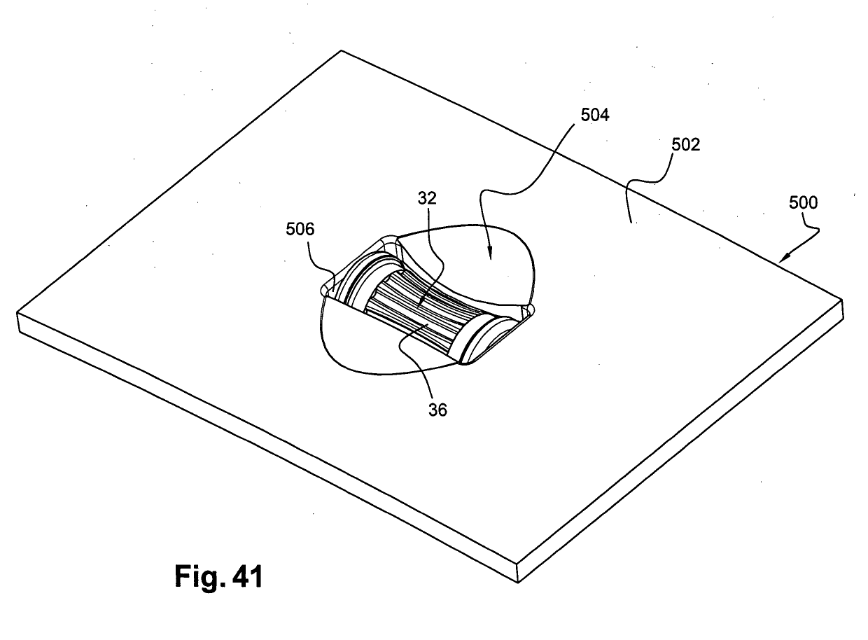

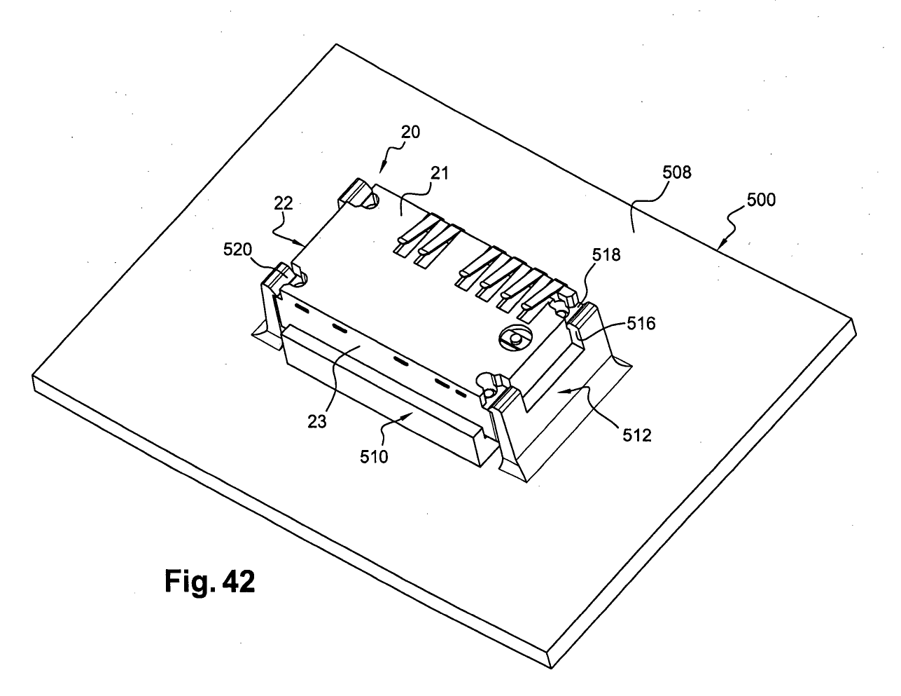

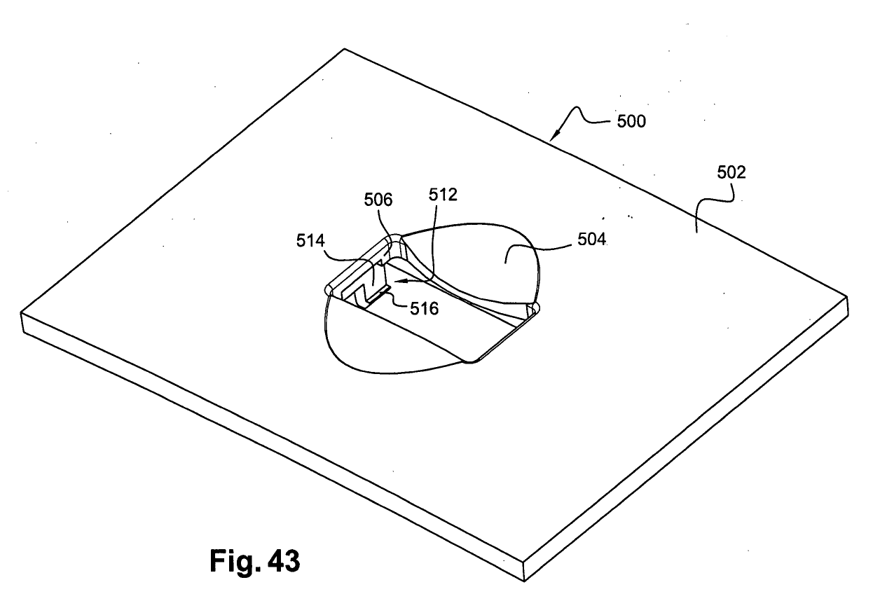

FIGS. 41 to 44 illustrate how the device according to the invention is elastically fitted into a portion of a wall or partition 500 in the shape of a plate belonging to an item of electronic apparatus or equipment furnished with the device 20 according to the invention that has just been described.

The plate 500 comprises, on its upper face 502, a central hollow recess 504 in the shape of a concave bowl which guides the user's finger towards the control member 32 which is received in a vertical housing with rectangular contour 506 formed in the plate 500 and which opens out.

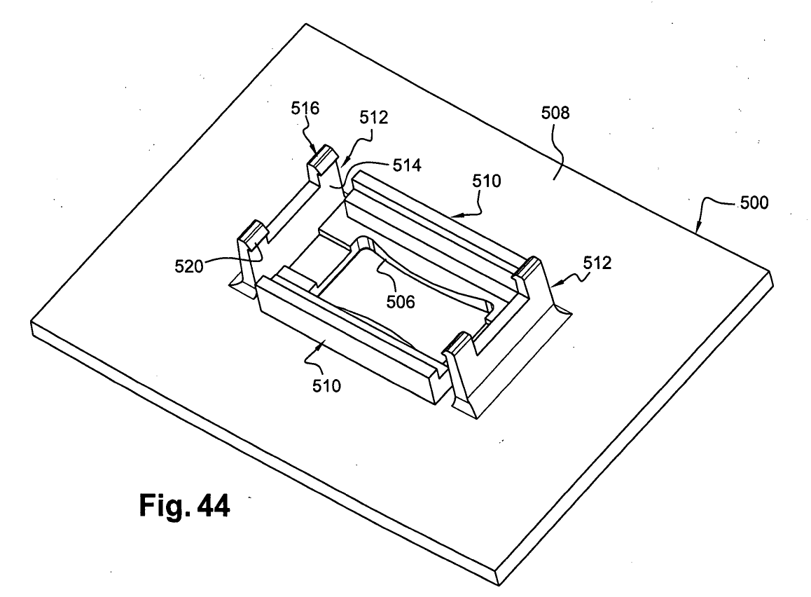

Beyond the lower face 508 (FIG. 44) of the plate 500, the latter is extended by opposite longitudinal guidance and positioning ribs 510 which interact in particular with the lateral faces 23 of the casing 22.

The plate 500 also comprises two vertical partitions 512 between the inner faces 514 of which the transverse and opposite faces of the casing 22 are received and which each comprise, at their free lower ends, two hooks 516 each of which is intended to be received in a complementary notch 518 formed opposite in a corner of the lower face 21 of the casing 22.

The upper part of each hook 516 is formed as a ramp 520 in order to cause an elastic deformation of the partition 514 and an elastic socket or “clip” attachment of the device 20 beneath the lower face 508 between the ribs 510 and the partitions 512 with elastic fitting of each hook 516 in a housing 518.

As can be seen in FIG. 41, the respective dimensions of the plate 500 and of the device 20 are such that the drum 36 is slightly flush with the centre of the bowl 504, but makes practically no projection beyond the plane of the upper face 502.

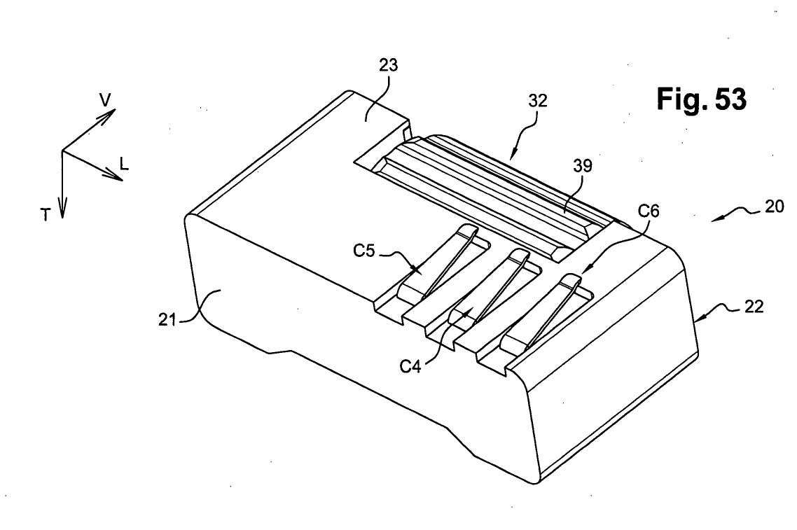

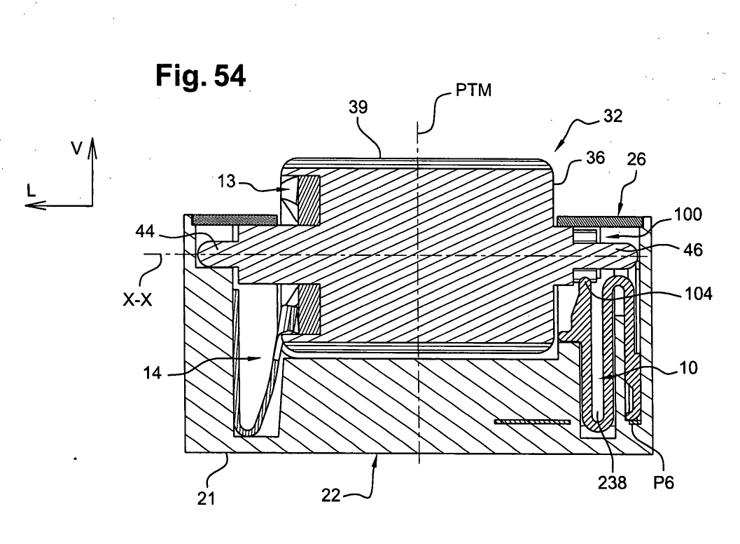

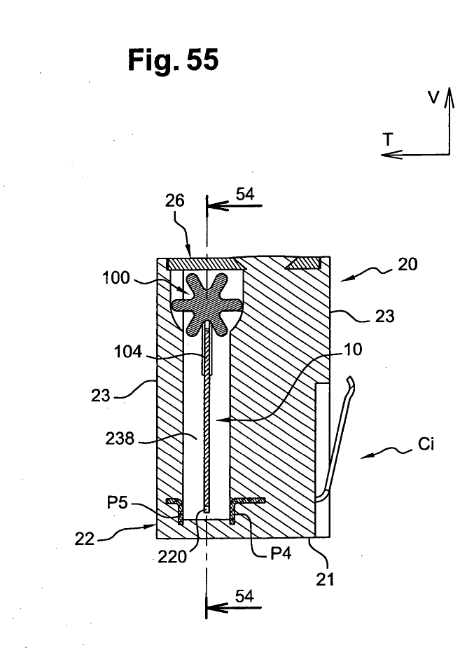

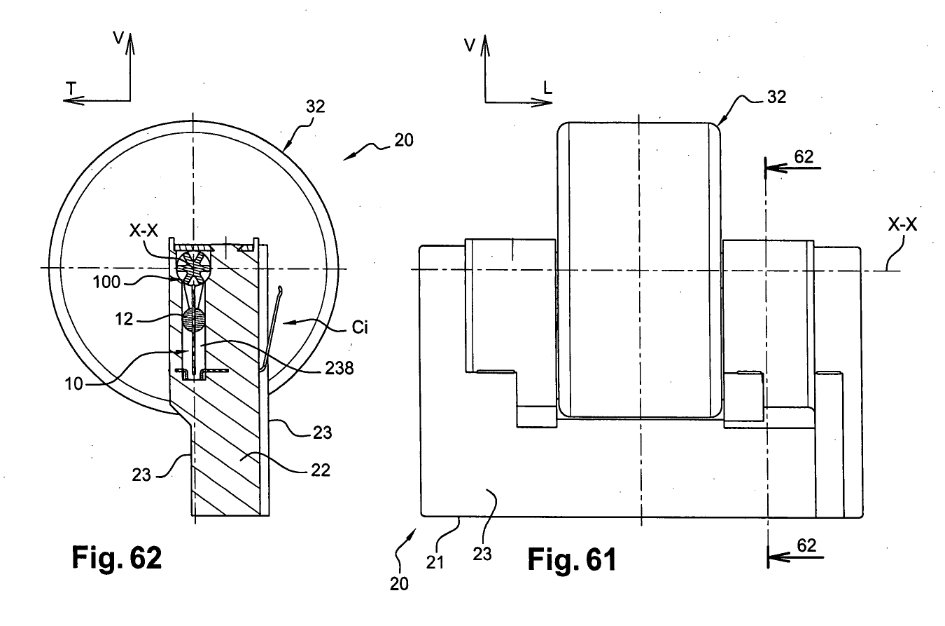

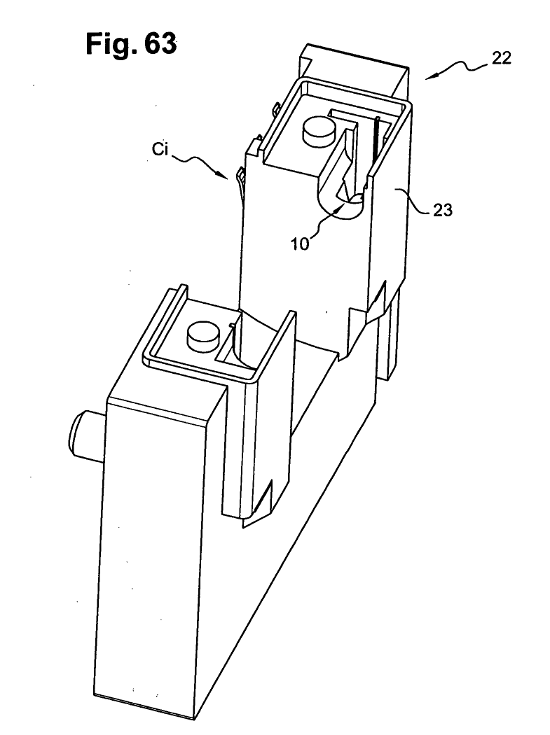

In the two exemplary embodiments of a roller with only two switching channels, “up” and “down”, illustrated in FIGS. 52 to 64, identical, analogous or similar components to those previously described are indicated by the same reference numbers.

As can be seen in these figures, the control device 20 uses an S-shaped mobile contact element 10 according to the teachings of the invention.

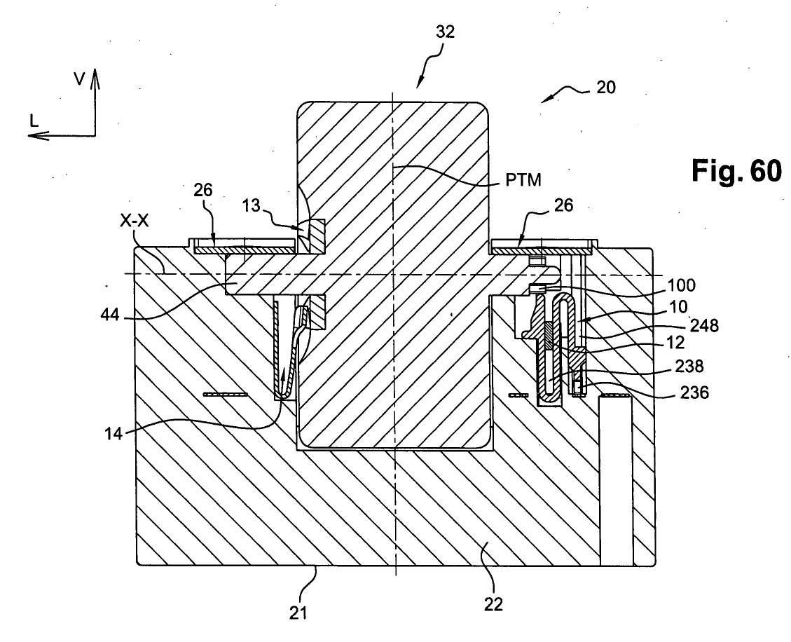

A damping and sealing block 12 (see FIG. 60) is again used here to effectively protect the fixed contacts P4 and P5 against dust.

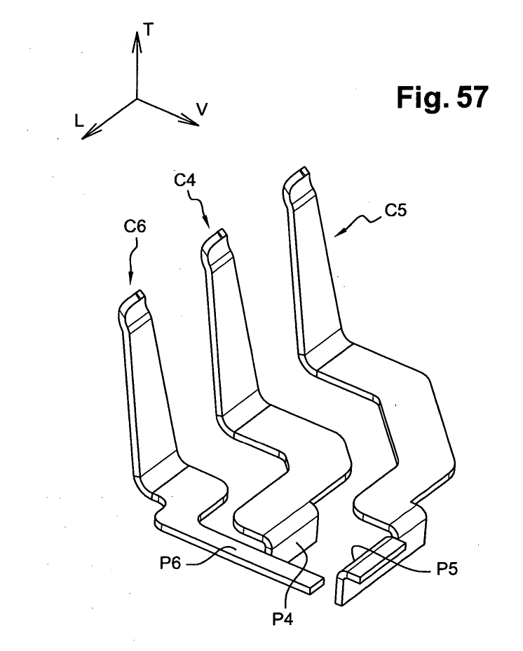

The design of the three contact elements C4, C5 and C6 (FIG. 57) constituting the fixed contact “grid” which are illustrated in FIG. 57 are easily made and the casing 22 is overmoulded on these elements Ci.

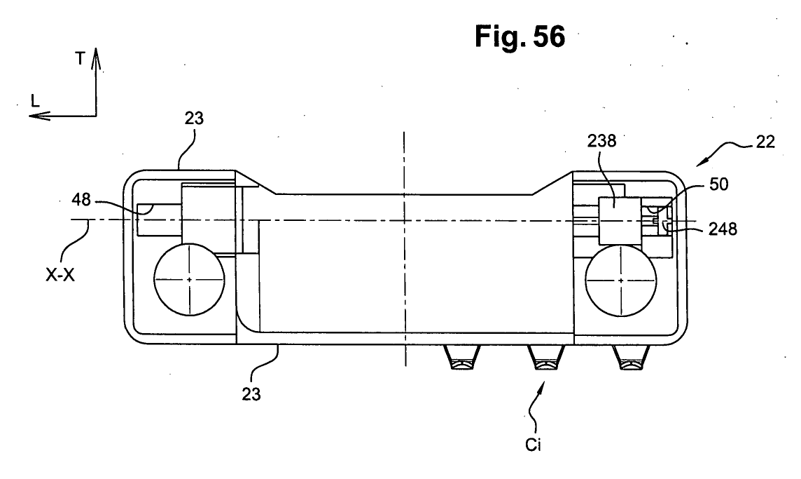

FIG. 56 is an end view along the arrow F56 of FIG. 52 which illustrates the lower casing 22 “empty”, that is to say without the components that it contains that comprise the drum 32 with its gearwheel 100, the mobile contact element 10, the pawl 14 and of course the flat cover 26.

As can be seen in particular in FIG. 52, a major portion of the drum 32, 36 protrudes transversely beyond one of the two lateral and vertical faces 23 of the casing 22.

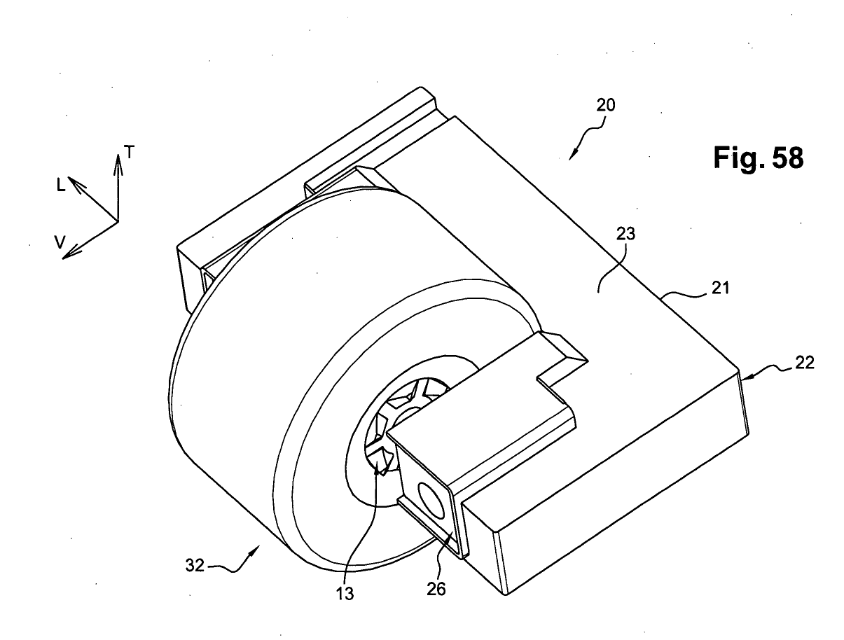

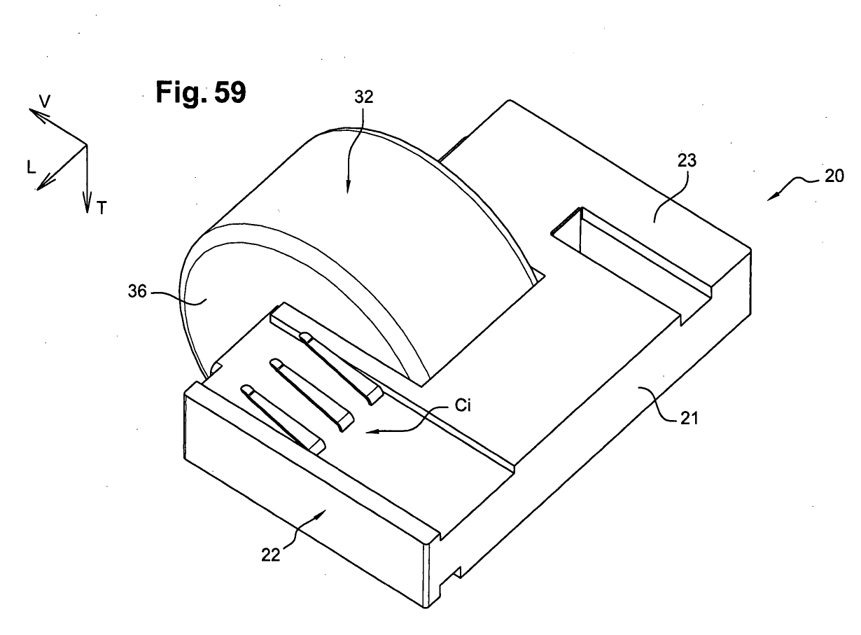

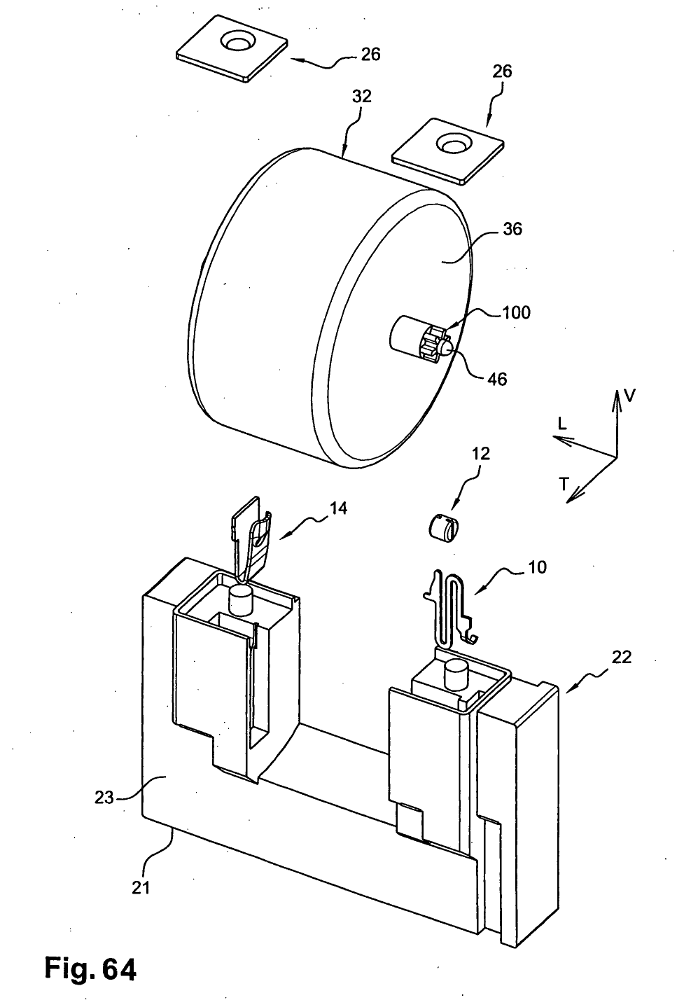

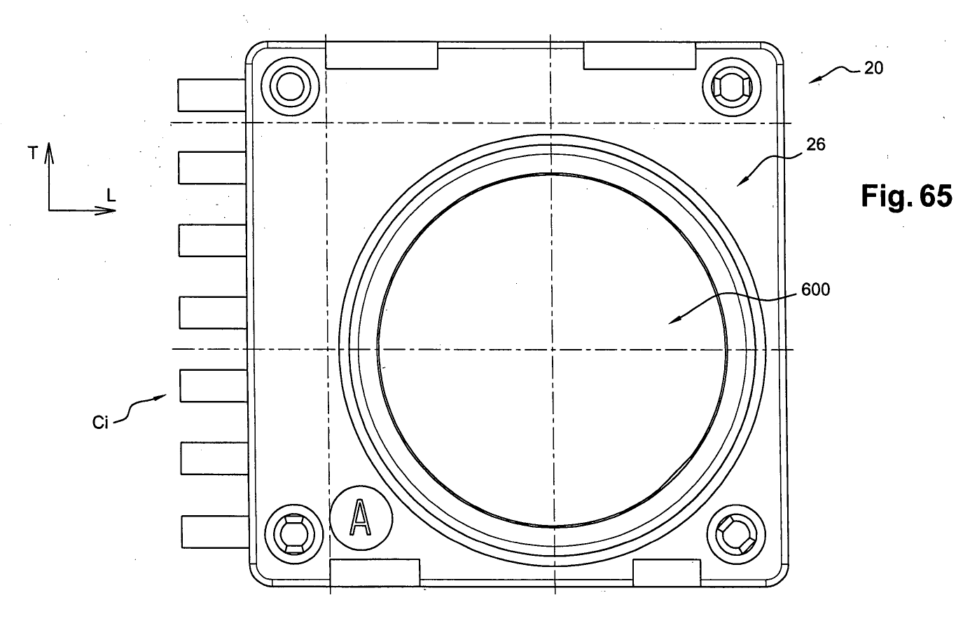

In the variant embodiment shown in FIGS. 58 and 64, the drum 32 is no longer a cylindrical drum with rectilinear generatrix and grooved as in FIGS. 52 to 57, but a large diameter wheel which greatly protrudes transversely either side of the casing 22, that is to say beyond each of the two longitudinal and vertical lateral faces 23.

The wheel or drum 32 may where necessary be made by bi-material moulding according to the technique used for example for computer control mouse balls, with a central hub made of hard thermoplastic and an injected radially external enveloping crown in an elastomer procuring a “soft touch”.

This configuration is particularly valuable when fixed or mobile members of the item of electronic apparatus or equipment that receives a control device 20 must be placed extremely close to the drum or wheel 32 in spaces or volumes delimited, on the one hand, by the casing 22 and, on the other hand, by two opposing shells (not shown) of the casings of the item of electronic apparatus or equipment.

The casing 22 with its elastic output connection lugs Ci is pressed against one face of a printed circuit board or card which comprises an opening or window for the passage of the corresponding part of the drum wheel 35 with the aid of a support (not shown) resting on the other lateral face 23 of the casing 22.

Such a support also comprises a cut-away for the passage of the wheel and the swellings forming hub-carriers in the faces 23, such a cut-away also providing the guidance and positional retention of the device 20 in the item of equipment.

The design principles according to the invention, particularly for the element 10, also find application in so-called “Trackball” devices comprising two analogous signal generators and described in documents WO-A-02/075641 and WO-A-04/024423.

The general design of a so-called “Trackball” control device is explained in detail in the two aforementioned international patent applications, the content of which can be referred to for further details.

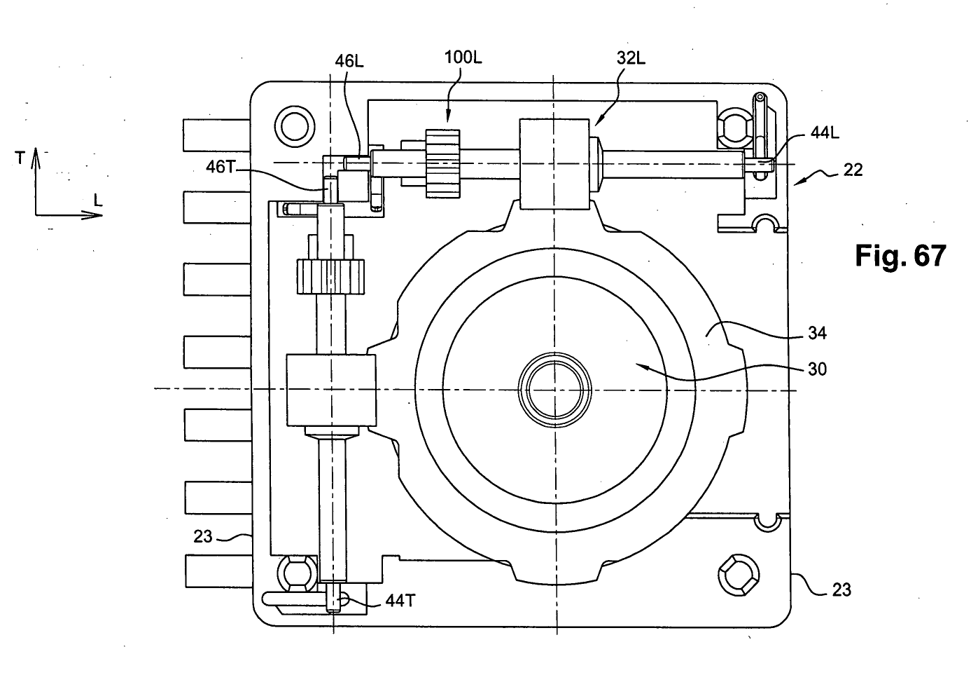

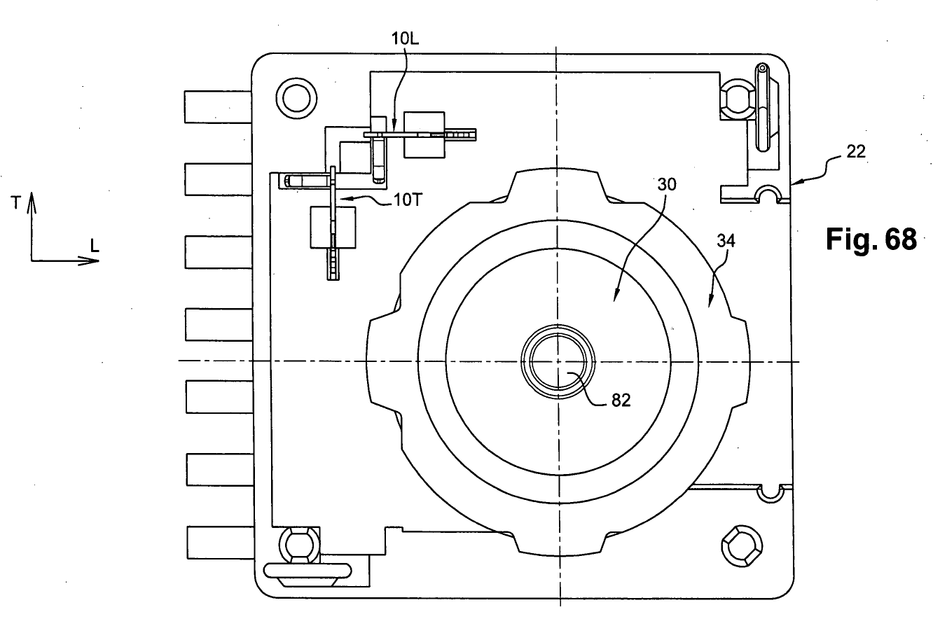

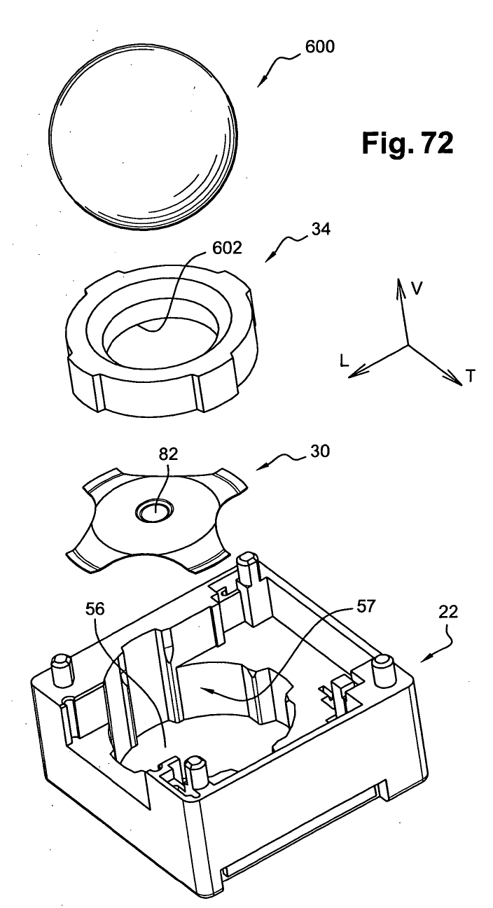

In the embodiment illustrated in FIGS. 65 to 72, components identical, similar or analogous to those previously described are indicated by the same reference numbers which are, where appropriate, marked “L” or “T” depending on whether they are components belonging to one or other of the two signal generators arranged, at right angles, in the transverse or longitudinal direction respectively and each of which comprises a control roller 32L, 32T which interacts with a common control ball 600.

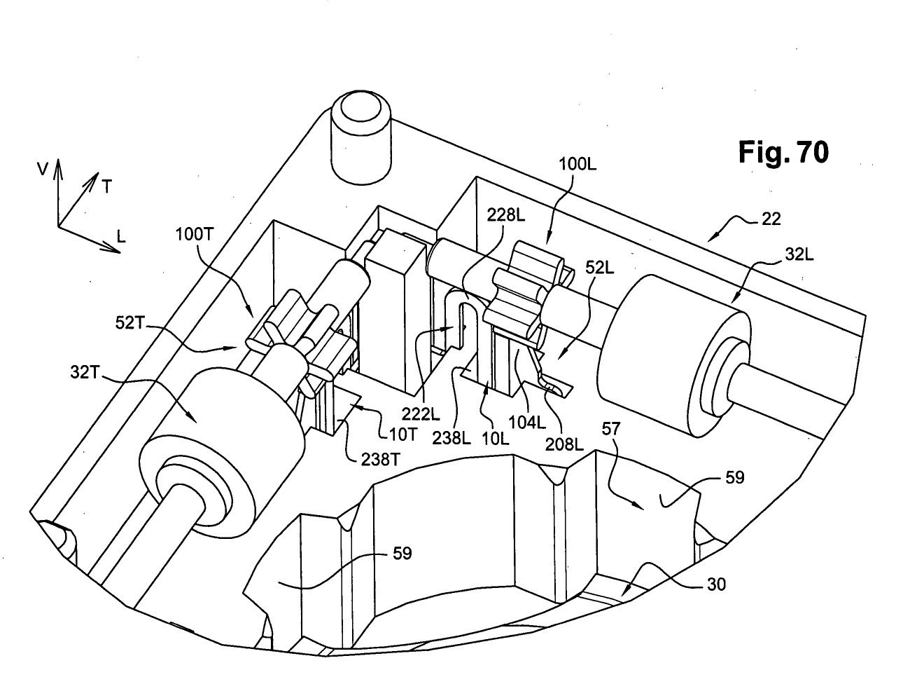

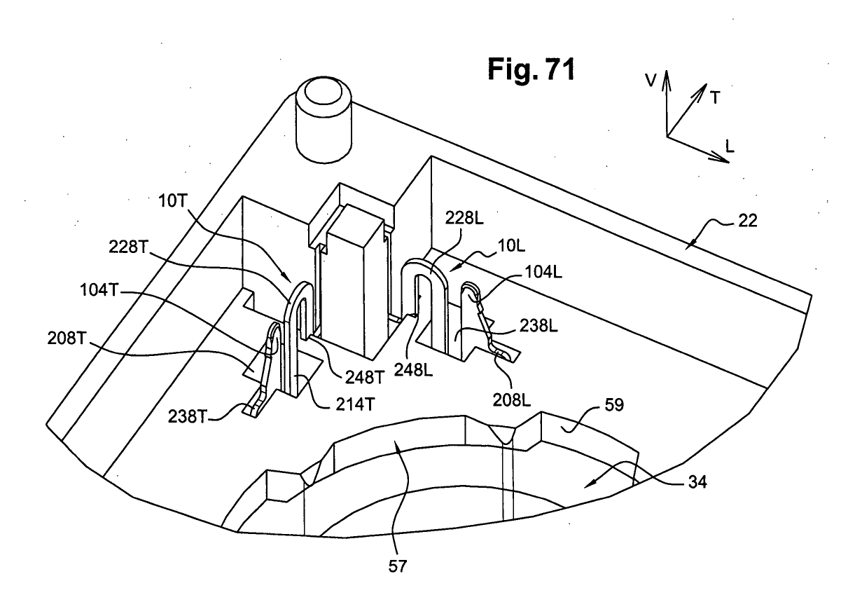

As can be seen in these figures, the two signal generators 52L, 52T (FIG. 70) are produced by using a mobile contact element 10L, 10T according to the teachings of the invention, both by its design illustrated in detail in FIGS. 27 to 29 and by its arrangement in the lower casing 22 with its damping and sealing means which may, for each element 10L, 10T, consist of a damping and sealing block like the previously described block 12, but which is not shown in the figures.

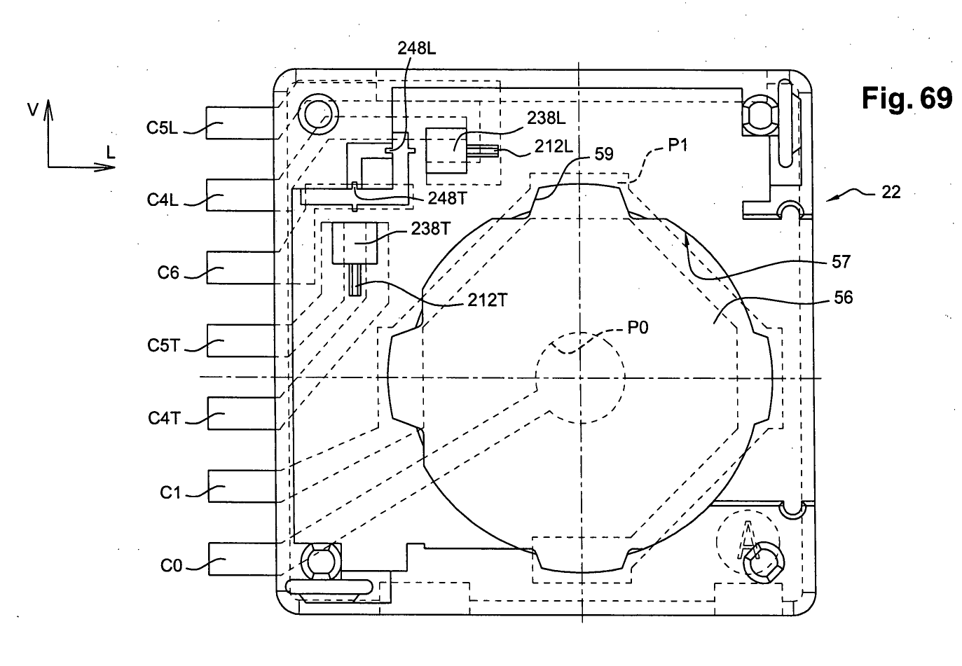

Shown schematically in dashed lines in FIG. 69 is the “grid” for electric connection of the various fixed electric contacts with the outside.

This grid consists of conductive elements around which the lower casing 22 of the “Trackball” 20 is overmoulded.

The cavity 57 formed in the central part of the casing 22 formed by the horizontal bottom 56 is formed so as to receive the common trigger element 30 with four branches each end of which is received in a complementary portion 59 of the housing 57, in the same way as the transverse branches B1 of the member 30 previously described with reference to the devices controlled by a roller-drum 30, 36.

When the user presses vertically on the control ball 600 to perform the so-called “SELECT” function, the lower part of the ball 600 acts on the central part of the common trigger member 30 so that this central part comes into electric contact with the central contact pad P0, while the free ends of the radial branches of the member 30 are pressing against and in permanent electric contact each with a portion of a common pad P1.

In order to ensure the sealing and protection against dust of these electric contact zones P0, P1, the “Trackball” type device shown in FIGS. 65 to 72 comprises a piece 34 moulded in flexible material, for example in elastomer, which is received in the housing 57 and which caps the common trigger member 30 with its electric contact zones.

The element 34 has the general form of an annular sealing crown whose external contour complements that of the housing 57, 59 with which it is in lateral sealed contact.

The lower annular edge 602 of the piece 34 rests in sealed manner on an annular peripheral zone opposite the upper face of the common trigger member 30 which is a zone subject to very slight movements when the trigger member 30 “collapses” under the action of the ball 600, thus providing a complete seal at all times.

What is claimed is:

1. A control device that includes a casing, a moveable control member that is rotatable in first and second opposite directions about an axis on said casing, a gearwheel with multiple teeth fixed to said control member, a pair of contacts, and a deflectable contact element which has a mount portion mounted on said casing, a deflectable portion in the path of said teeth, and a contacting portion that deflects when said deflectable portion is deflected, said deflectable portion lying between said pair of contacts to engage a selected one of said contacts depending upon the direction of control member rotation, wherein:
said deflectable contact element is formed of a piece of sheet metal that forms said deflectable portion, said mount portion, and said contacting portion.

2. The control device described in claim 1 wherein:
said contact element has at least a first elbow extending in a primarily 180° turn about an axis that is normal to the sheet metal, with said mount portion and said deflectable portion lying beyond opposite sides of said elbow.

3. The control device described in claim 2 wherein:
said deflectable contact element includes at least first, second and third vertically elongated stems, said first stem forming said mount portion, and upper ends of said first and second stems joined by a second elbow extending in a primarily 180° turn about an axis that is normal to said sheet material;
said third stem having an upper end forming said deflectable portion and having a lower end joined by said first elbow to a lower end of said second stem, with said first elbow forming said contacting portion.

4. The control device described in claim 3 including:
a damper element (12) of elastomeric material having a pair of slot portions, and said second and third stems each lies in one of said slot portions.

5. The control device described in claim 1 wherein:
said mount portion, deflectable portion, and contacting portion of said deflectable contact element all lie in a common plane.

6. The control device described in claim 1 wherein:
said deflectable contact element has a vertically elongated stem, with said deflectable portion lying at an upper end of said stem and said contacting portion lying adjacent to a lower end of said stem;
said stem having an articulation branch that extends largely horizontally from a location on said stem that lies between said stem upper and lower ends;
said casing forms a slot that receives said articulation branch.

7. The control device described in claim 1 wherein said control member has opposite ends, and including a trigger member with deflectable opposite branches each lying under a different one of said control member ends, and a pair of bottom contacts each lying under one of said opposite branches, to generate a signal when one of said control member ends is depressed to depress one of said branches against one of said bottom contacts, wherein:
said control member has a pair of shaft portions each projecting along said axis from a different one of said control member opposite ends, and said casing has a pair of vertical slots that each receives one of said shaft portions and allows each of said shaft portions to slide up and down in the slot, said trigger member urging each of said shaft portions upward.

8. The control device described in claim 7 including:
a elastomeric O-ring extending around each of said shaft portions at a shaft location lying beyond a corresponding one of said slots, each O-ring being pressed up against said casing, whereby to help damp said control member.

9. The control device described in claim 1 including a pair of coil spring mounted on said casing, and wherein:
each of said bottom contacts comprises an upper end of one of said coil springs.

10. The control device described in claim 1 including a sheet metal trigger member having a center member part and a plurality of branch member parts radiating from said center member part, and a plurality of bottom contacts each lying under one of said member parts, and wherein:
said casing includes a lower casing part having an upwardly opening cavity and a sealing member of elastomeric material lying in said cavity, said sealing member having a bed plate and a plurality of tubes extending upwardly from said bed plate, a plurality of said contact elements each lies in one of said tubes, and a plurality of said trigger member parts each lies on top of one of said tubes.

11. A control device that includes a casing, a manually moveable control member that lies in said casing and that is rotatable about an axis and that is depressable, a mechanism that senses rotation of said control member about said axis, a plurality of branch-engaging contacts, a sheet metal trigger member having a trigger member center and a plurality of trigger member branches extending from said trigger member center, a plurality of said branches each lying closely over one of said branch-engaging contacts, said trigger member lying under said control member with said branches positioned so manual depression of selected portions of said control member depress corresponding ones of said branches against one of said branch-engaging contacts, wherein:
said control member comprises a drum and has a pair of opposite shaft portions projecting along said axis from opposite ends of said drum;
said casing has a pair of slots with upper slot end walls, said slots each receiving one of said shaft portions to allow opposite ends of said drum to each be depressed, with a pair of opposite ones of said branch member parts resiliently urging opposite ends of said shaft portions upward against said upper slot end walls.

12. The control device described in claim 11 including:
a pair of elastomeric O-rings encircling said shaft portions at locations outside said slots so said O-rings move up and down with said shaft portions, said casing having O-ring engaging walls that engage said O-rings when said control member is not depressed.

13. The control device described in claim 11 wherein:
said drum has a middle portion and has opposite end portions with cylindrical tracks thereon;
said center part of said trigger member lies under and out of contact with said drum middle portion, and said plurality of trigger member branches includes a pair of opposite branches that each lies under and in contact with one of said tracks; and including
a middle contact that is in constant electrical connection with said trigger member center, and a pair of said branch-engaging conducts each lies slightly below one of said opposite branch member parts so a branch member part engages a branch-engaging contact when a corresponding end of the drum is depressed.

14. The control device described in claim 13 wherein:
said drum has a concave middle portion lying over said center part of said trigger member, to thereby space the drum middle portion from the trigger member center.

15. The control device described in claim 13 wherein:
said casing includes an elastomeric member of elastomeric material lying under said control member, said elastomeric member having a plurality of upwardly-extending elastomeric tubes, a plurality of said branch-engaging contacts each lies in one of said tubes, and said opposite branch member parts each lies against a top of one of said elastomeric tubes.

16. The control device described in claim 11 including a gearwheel fixed on one of said shaft portions, and a deflectable contact element having a mount portion mounted on said casing, a deflectable portion lying in the path of teeth of said gearwheel, and a contacting portion that deflects when said deflectable portion is deflected and that lies between a pair of rotation-sensing contacts, wherein:
said deflectable contact element is formed of a piece of sheet metal and has three vertically-elongated stems including first and second stems having lower ends joined by a first 180° elbow portion and with said second stem and a third stem having upper ends joined by a second 180° elbow portion;
an upper end of said first stem lying between teeth of said gearwheel, and said first 180° elbow lying between said rotation-sensing contacts.

17. A control device that includes a casing, a manually moveable control member that lies in said casing and that has opposite ends that are depressable, a trigger member having branches lying under said control member, and a plurality of bottom contacts each lying under one of said branches, including:
an elastomeric member lying in said casing under said control and trigger members, said elastomeric member forming a plurality of elastomeric tubes that have passages, and said bottom contacts each lies in one of said tubes, with a plurality of said branches each lying on top of each of a plurality of said tubes.

18. The control device described in claim 17 wherein:
each of a plurality of said branch covers the entire top of the passage that it lies on, to thereby keep out dust from the contacting surfaces.

19. The control device described in claim 18 wherein:
the passages of a plurality of said elastomeric tubes are connected together.

20. The control device described in claim 17 wherein:
said elastomeric member has a pair of elastomeric heels, and said control member has opposite ends with sections positioned to contact said elastomeric heels when the corresponding control member end is depressed.
